(19) United States
(12) Patent Application Publication
(10) Pub. No.: US 2018/0115814 A1
(43) Pub. Date: Apr. 26, 2018

(54) SYSTEM AND METHOD TECHNOLOGIES FOR MEDITATION

(71) Applicants: Jill Willard, Manhattan Beach, CA (US); Carol Anne Lamssies, Hermosa Beach, CA (US)

(72) Inventors: Jill Willard, Manhattan Beach, CA (US); Carol Anne Lamssies, Hermosa Beach, CA (US)

(21) Appl. No.: 15/792,022

(22) Filed: Oct. 24, 2017

Related U.S. Application Data
(60) Provisional application No. 62/412,158, filed on Oct. 24, 2016.
(60) Provisional application No. 62/412,655, filed on Oct. 25, 2016.
(60) Provisional application No. 62/412,181, filed on Oct. 24, 2016.
(60) Provisional application No. 62/412,771, filed on Oct. 25, 2016.

(51) Int. Cl. H04R 1/10; H04Q 9/00

(52) U.S. Cl. CPC H04R 1/1041; H04Q 2209/50; H04R 2420/07; H04Q 9/00

(57) ABSTRACT

A method comprising: receiving, via a mobile device, a pH reading from a wearable device, wherein the wearable device includes a pH sensor that obtained the pH reading, wherein the mobile device stores a key and a first meditation content, wherein the key maps onto the first meditation content; accessing, via the mobile device, the first meditation content based on the pH reading corresponding to the key; outputting, via the mobile device, the first meditation content; receiving, via the mobile device, a user input responsive to the first meditation content; and taking, via the mobile device, an action responsive to the user input.

### CROSS-REFERENCE TO RELATED APPLICATIONS

This application claims the benefit of priority to U.S. Patent Applications (1) 62/412,158, filed on 24 Oct. 2016, (2) 62/412,655, filed on 25 Oct. 2016, (3) 62/412,181 filed on 24 Oct. 2016, and (4) 62/412,771 25 Oct. 2016, each of which is incorporated by reference herein for all purposes.

### TECHNICAL FIELD

This disclosure relates to electronic and mechanical aspects of meditation.

### BACKGROUND

There is a desire for a technology to enable a meditation experience based on a potential of hydrogen (pH) value of a meditator and a tactile reminding device. However, such technology does not exist. Therefore, this disclosure enables such technology.

### SUMMARY

In an embodiment, a method comprises: receiving, via a mobile device, a pH reading from a wearable device, wherein the wearable device includes a pH sensor that obtained the pH reading, wherein the mobile device stores a key and a first meditation content, wherein the key maps onto the first meditation content; accessing, via the mobile device, the first meditation content based on the pH reading corresponding to the key; outputting, via the mobile device, the first meditation content; receiving, via the mobile device, a user input responsive to the first meditation content; and taking, via the mobile device, an action responsive to the user input.

In an embodiment, a method comprises: adhering a patch to a forehead of a user, wherein the patch includes a pH sensor configured to obtain a pH reading from the forehead; and transmitting the pH reading from the patch to a mobile device.

In an embodiment, a device comprises: a headphone including a headband and an earpiece; and a pH sensor, wherein at least one of the headband or the earpiece includes the pH sensor.

In an embodiment, a device comprises: a cord including a first end portion and a second end portion, wherein the cord is tied in a first knot between the first end portion and the second end portion such that a loop is formed between the first end portion and the second end portion, wherein the loop includes a plurality of second knots spaced apart from each other; and a member mounted onto the loop such that the loop extends through the member and such that the member can travel over the knots and such that the first knot stops the member.

In an embodiment, a device comprises: a fabric including a side hosting a linear sequence of projections extending therefrom.

In an embodiment, a method comprises: accessing a fabric including a side hosting a plurality of linear sequences of projections extending therefrom; and cutting the fabric into a plurality of sections such that the sections include the linear sequences of projections.

Note that this disclosure is embodied in various forms illustrated in a set of accompanying illustrative drawings and variations are contemplated as being a part of this disclosure, limited only by a scope of various claims recited below.

### BRIEF DESCRIPTION OF DRAWINGS

The set of accompanying illustrative drawings shows various example embodiments of this disclosure. Such drawings are not to be construed as necessarily limiting this disclosure. Like numbers and/or similar numbering scheme can refer to like and/or similar elements throughout.

FIG. 1 shows a diagram of an embodiment of a system according to this disclosure.

FIGS. 2a-2b show a plurality of flowcharts of a plurality of embodiments of a plurality of methods for generating a meditation content according to this disclosure.

FIG. 3 shows a diagram of an embodiment of a user meditating and employing a mobile device and a wearable device according to this disclosure.

FIG. 4 shows a diagram of an embodiment of a user meditating and employing a mobile device and a wearable device, where the wearable device includes a pH sensor and a heart sensor according to this disclosure.

FIG. 5 shows a diagram of an embodiment of a user meditating and employing a tactile device according to this disclosure.

FIGS. 6a-6m show a diagram of an embodiment of a tactile bracelet according to this disclosure.

FIGS. 7a-7k show a diagram of an embodiment of a fabric including a linear sequence of features according to this disclosure.

FIGS. 8-11 show a diagram of an embodiment of a tactile bracelet according to this disclosure.

FIG. 12 shows a diagram of an embodiment of a fabric including a linear sequence of features according to this disclosure.

FIG. 13 shows a diagram of an embodiment of a wearable device obtaining a pH sensor reading and communicating with a mobile device in communication with a server according to this disclosure.

FIG. 14 shows a flowchart of an embodiment of a method of meditation according to this disclosure.

FIGS. 15-17 show a plurality of diagrams of a plurality of storage mediums with a plurality of meditation instructions according to this disclosure.

FIG. 18 shows a diagram of an embodiment of a meditation technique according to this disclosure.

FIG. 19 shows a flowchart of an embodiment of a meditation technique according to this disclosure.

FIGS. 20a-20e show a diagram of an embodiment of a bracelet with visually distinct segments according to this disclosure.

FIGS. 21a-21b show a diagram of an embodiment of a cord with visually distinct segments according to this disclosure.

FIGS. 22a-22b show a diagram of an embodiment of a cord with linearly spaced features and a member mounted onto the cord according to this disclosure.

FIGS. 23a-23e show a diagram of an embodiment of a bracelet tying technique with a cord according to this disclosure.

### DETAILED DESCRIPTION

Generally, this disclosure discloses a first device including a pH sensor that is configured to (1) obtain a pH reading from a user of the first device, (2) send the pH reading from the first device to a second device such that the second device can process the pH reading and generate a content based on the pH reading. For example, the first device can include a wearable device, such as a bracelet, a headband, a skin patch, a headphone, or others, whereas the second device can include a mobile device, such as a smartphone, a tablet, or others. Further, this disclosure discloses a meditation device including a linear sequence of features for a tactile user engagement. For example, the meditation device can included a bracelet, a fabric, or others, whereas the features can include projections, such as knots, beads, or others. Note though that this disclosure is now described more fully with reference to the set of accompanying illustrative drawings, in which example embodiments of this disclosure are shown. This disclosure can be embodied in many different forms and should not be construed as necessarily being limited to the example embodiments disclosed herein. Rather, the example embodiments are provided so that this disclosure is thorough and complete, and fully conveys various concepts of this disclosure to those skilled in a relevant art.

Various terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

Although terms first, second, and others can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from various teachings of this disclosure.

Various terminology used herein is for describing particular example embodiments and is not intended to be necessarily limiting of this disclosure. As used herein, various singular forms “a,” “an” and “the” are intended to include various plural forms as well, unless a context clearly indicates otherwise. Various terms “comprises,” “includes” and/or “comprising,” “including” when used in this specification, specify a presence of stated features, integers, steps, operations, elements, and/or components, but do not preclude the presence and/or addition of one or more other features, integers, steps, operations, elements, components, and/or groups thereof.

As used herein, a term “or” is intended to mean an inclusive “or” rather than an exclusive “or.” That is, unless specified otherwise, or clear from context, “X employs A or B” is intended to mean any of a set of natural inclusive permutations. That is, if X employs A; X employs B; or X employs both A and B, then “X employs A or B” is satisfied under any of the foregoing instances.

US Patent Application Publications 20150061837, 20160066894, 20160324451 and 20160166197 and WIPO Publication WO2016197116 are incorporated by reference herein for all purposes, such as for meditation techniques, hardware, software, and others. If any disclosures of such disclosures conflict in part and/or in whole with this disclosure, then to an extent of a conflict, if any, and/or a broader disclosure, and/or broader definition of terms, this disclosure controls. If such disclosures conflict in part and/or in whole with one another, then to an extent of a conflict, if any, a later-dated disclosure controls.

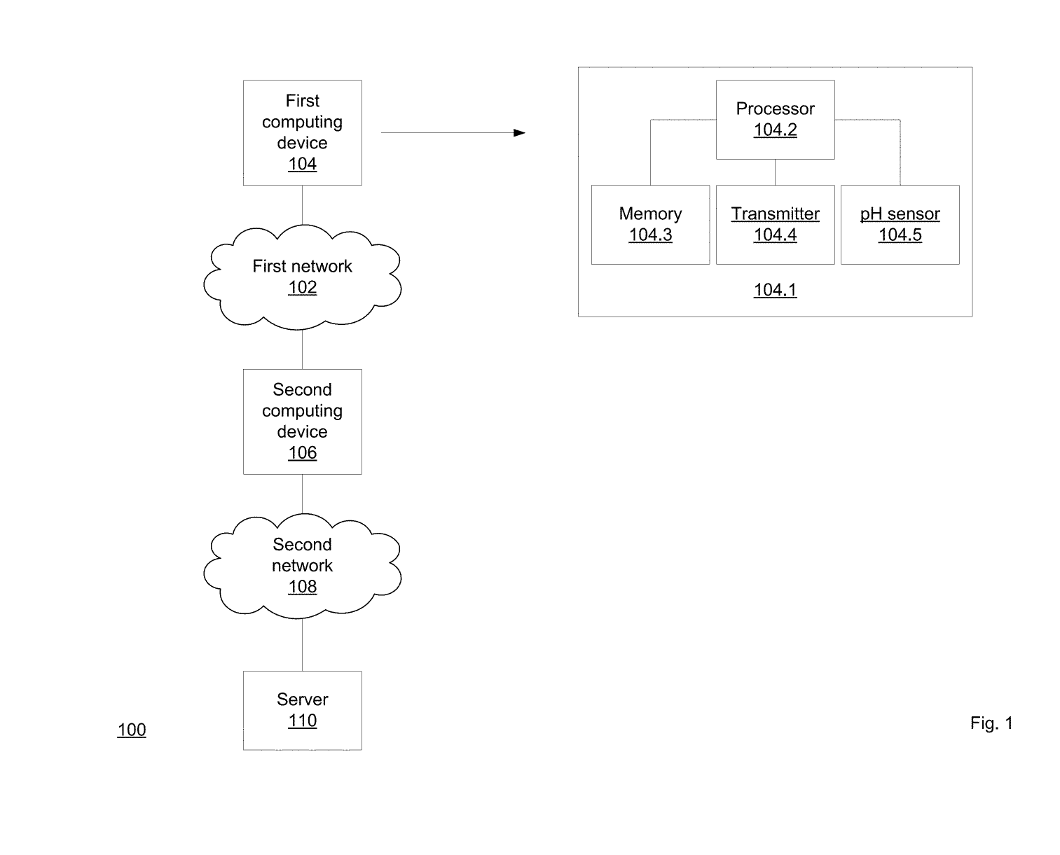

FIG. 1 shows a diagram of an embodiment of a system according to this disclosure. In particular, a system 100 includes a first network 102, a first computing device 104, a second computing device 106, a second network 108, and a server 110. The first device 104 and the second device 106 are in communication with the first network 102. The second device 106 and the server 110 are in communication with the second network 108.

The first network 102 includes a personal area network (PAN), a local area network (LAN), or others, whether wired or wireless, whether based on a radio communication, an optical communication, an infrared communication, a sound communication, whether encrypted or unencrypted. For example, the first network 102 can be based on a Bluetooth protocol, a ZigBee protocol, or others. The second network 108 includes a LAN, a wide area network (WAN), a cellular network, a satellite network, or others, whether wired or wireless, whether based on a radio communication, an optical communication, an infrared communication, a sound communication, whether encrypted or unencrypted. For example, the second network 108 can be based on an Institute of Electrical and Electronics Engineers (IEEE) 802.11 protocol.

The first device 104 can be embodied as a wearable, a garment, a jewelry item, a bedding item, an implantable, an exercise device, or any other device that can contact an outer surface of a skin of a user on any portion thereof. For example, the first device 104 can be embodied as a bracelet, an anklet, a headband, a headphone, a skin patch, an adhesive bandage, a tubular cuff, a sleeve, a collar, a vest, a belt, a robe, a sock, a glove, a scarf, a shawl, a pashmina, a tie, a cufflink, a hat, a pair of pants, a pair of shots, a pair of underwear, a bra, a jersey, a helmet, a cast, a shoe, a swimming suit, a bikini, a T-shirt, a sweater, a turtleneck, an eyewear frame, a contact lens, an earring, a necklace, a ring, a wristband, a hearing aid, an implant, a pillow, a pillowcase, a sheet, a blanket, a duvet, a duvet cover, a comforter, a sleeping bag, a towel, a pad, a mattress, a pad, a rug, a treadmill, a rowing machine, a weight lifting machine, a ball, a racket, a jump rope, a mouse, a keyboard, a wrist pad, a bicycle handlebar, a phone/tablet case, a steering wheel, or any other device that can contact the outer surface of the skin of the user on any portion thereof. In some embodiments, the first device 104 can be positioned anywhere on the user, externally or internally, whether invasively or non-invasively, such as within the skin of the user, such as within an inner layer of the skin, or in proximity of or in contact with a nerve of the user, a muscle of the user, an organ of the user or others, on any portion thereof. For example, the first device 104 can be positioned within a mouth or torso of the user. The first device 104 can be powered via a power source, such as a mains electricity source, such as via a power cord, or via a battery, which may be rechargeable.

The first device 104 includes a housing 104.1 that houses a processor 104.2, a memory 104.3 coupled to the processor 104.2, a transmitter 104.4 coupled to the processor 104.2, and a pH sensor 104.5 coupled to the processor 104.2, any of which can be powered via the power source. The housing 104.1 can be rigid or flexible and can include plastic, rubber, metal, fabric, or others. The housing 104.1 can house the processor 104.2, the memory 104.3, the transmitter 104.4, or the pH sensor 104.5 via adhering, fastening, mating, or others.

The processor 104.2 can include a logic controller, a microprocessor, whether a single core or a multi core, or others. The memory 104.3 can include a volatile or a non-volatile memory, such as a flash memory or others. The transmitter 104.4 can be configured for a communication, whether wired or wireless, whether in a line of sight or out of a line of sight, such as via a radio technique, an optic technique, an infrared technique, a sound technique, or others. In some embodiments, the transmitter 104.4 is included in a transceiver housed within the housing 104.1. The pH sensor 104.5 is configured to obtain a pH reading from the outer surface of the skin of the user, whether non-invasively or invasively. For example, the pH reading can be obtained based on a chemical, electrical, or thermal property of the outer surface of the skin of the user, including hair, sweat, or dermis. For example, the pH reading can be obtained in a holographic manner/colorimetrics or via a solid state or glass electrode. In some embodiments, the pH reading can be obtained from anywhere on the user, externally or internally, whether invasively or non-invasively, such as within the skin of the user, such as within an inner layer of the skin, or in proximity of or in contact with a nerve of the user, a muscle of the user, an organ of the user or others, on any portion thereof. For example, the pH sensor 104.5 can include a pH meter that is configured to measure a hydrogen-ion activity on the outer skin surface of the user based on a difference in an electrical potential between a pH electrode and a reference electrode, with the pH electrode and the reference electrode being included in the pH meter, and with the difference in the electrical potential relating to how acidic or basic the outer surface of the skin is, i.e. the pH reading. The pH reading can be on a scale between 0 and 14, with 7 being neutral, with less than 7 being acidic, and with greater than 7 being basic, as understood to skilled artisans. Note that the pH sensor 104.5 can be analog or digital and can output the pH reading in an analog or digital manner, whether raw or converted into another format.

The second device 106 can be embodied as a stationary or mobile device, such as a desktop, a laptop, a smartphone, a tablet, an optical head mounted display, a wearable, a videogame console, or others. The second device 106 includes a processor, a memory, a transceiver, an input device, such as a mouse, a keyboard, whether physical or virtual, a touch-enabled display, a camera, a microphone, or others, and an output device, such as a speaker, a display, an oscillator, or others. For example, the display can be a plasma display, a liquid crystal display (LCD), an electrophoretic display, or others. In some embodiments, the device 106 is configured to present an augmented reality content, as disclosed herein. The second device 106 further includes a logic, whether hardware or software, that is included in an operating system of the second device 106 or runs on the operating system of the device 106 and is able to operate based on the pH reading received from the first device 104, as disclosed herein. For example, such operation can include output meditation content, interact with the user, or others. Note that the logic can include other functionality, such as authentication, logging, biometric management, exercise management, meditation management, or others.

The server 110 runs an operating system and an application, with the application running on the operating system. In some embodiments, the server 110 hosts or has access to a database, such as a relational database, an in-memory database, a graphical database, a NoSQL database, or others. For example, the database can include a plurality of records, where each of the records contains a plurality of fields associated with a plurality of categories, such as a user identifier, a user address, a user phone number, a user email, a user medical record, a pH reading, a biometric reading, or others. Note that the database can include or be coupled to an electronic medical records (EMR) database, whether local or remote thereto, whether using a same or different schema.

In one mode of operation, the second device 106 can receive a pH reading from the first device 104 over the first network 102, such as directly over a PAN. The second device 106 can (1) output, such as via the display, the augmented reality content, the speaker, or others, a first meditation content based on the pH reading, (2) receive a user input responsive to the first meditation content, such as via the keyboard, the mouse, or others, (3) take an action responsive to the user input. For example, the action can include outputting, such as via the display, the augmented reality content, the speaker, or others, a second meditation content, writing the user input into a data structure, whether local to or remote from the second device 106, interface with another computing device, such as the server 110, or others.

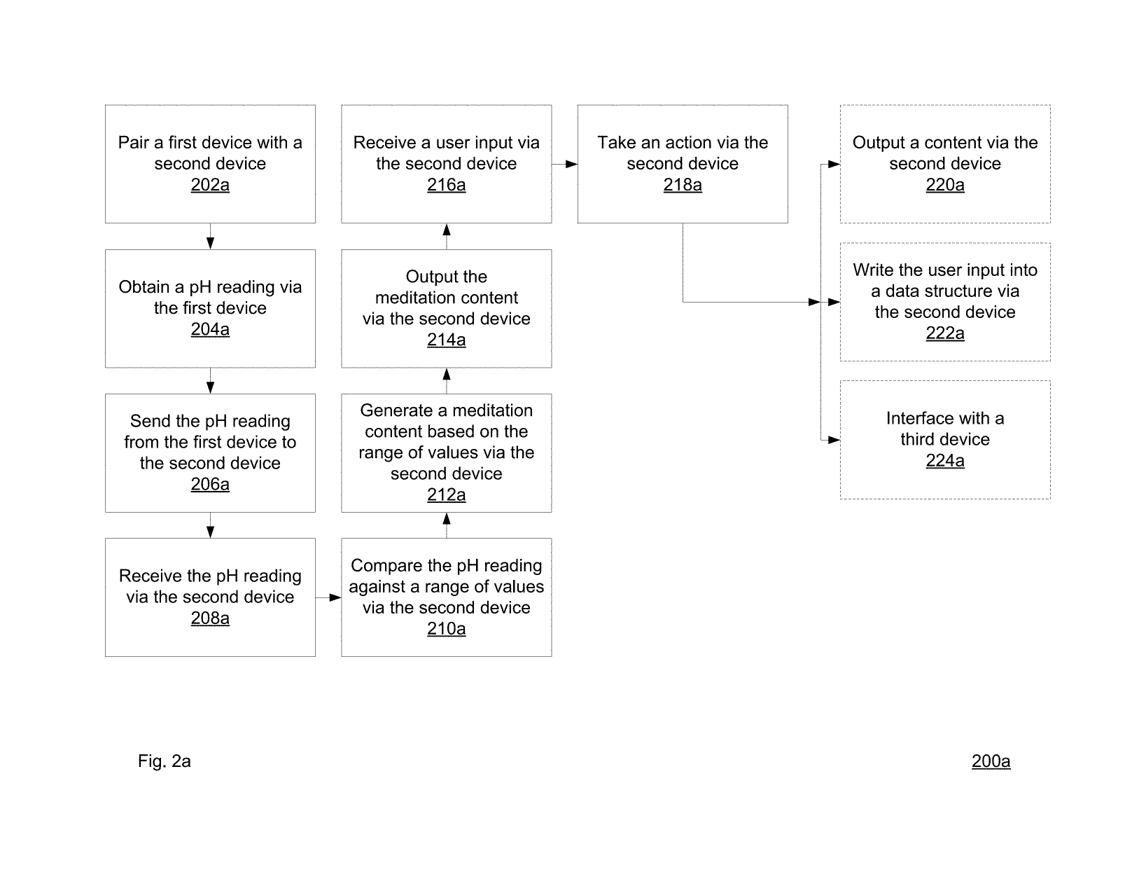

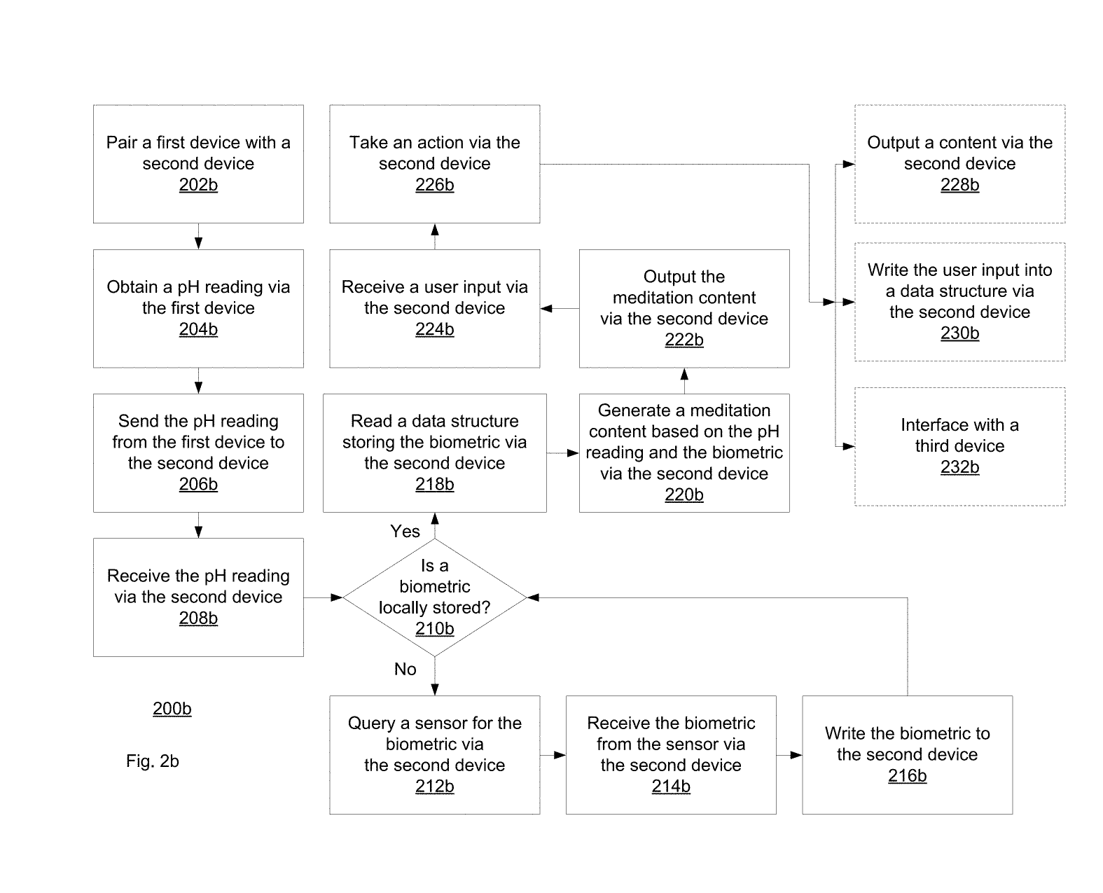

FIGS. 2a-2b show a plurality of flowcharts of a plurality of embodiments of a plurality of methods for generating a meditation content according to this disclosure. In particular, as shown in FIG. 2a, a method 200a can be performed via the system 100.

In block 202a, the first device 104 is paired with the second device 106 over the first network 102. For example, the first device 104 can be embodied as a wearable device, such as a bracelet, or others, and the second device 106 is embodied as a mobile device, such as a smartphone or others, with the first network 102 being embodied as a PAN, such as based on a Bluetooth protocol or others.

In block 204a, the first device 104 hosts the pH sensor 104.5 that contacts the user, such as the outer surface of the skin of the user or others, and obtains the pH reading of the user.

In block 206a, the first device 104 sends the pH reading to the second device 106 over the first network 106, such as wirelessly or others. The first device 104 can send the pH reading in a raw state or convert into a format suitable for sending to the second device 106.

In block 208a, the second device 106 receives the pH reading from the first device 104, such as wirelessly or others. The second device 106 receives the pH reading in the raw state or in the format suitable for receiving from the first device 104. In some embodiments, the pH reading includes a plurality of pH readings over a time period, such as on a second, hour, daily, weekly, monthly basis.

In block 210a, the second device 106 compares the pH reading against a range of values stored local to or remote from the second device 106, such as the server 110 or others. For example, the second device 106 calls a function or accesses a data structure, such as a hash function, a hash table, a lookup table (LUT), an array, or others, that includes a plurality of keys and a plurality of contents. The keys can include individual values, whether whole, fractions, or decimals, or ranges of values. For example, the keys can include alphanumeric data, such as in a binary, denary, hexadecimal, or other formats. For example, the keys can include individual values such as 6, 9.3, 3.4, 12, or others. For example, the keys can include value ranges such as 1-4, 4.1-6.8, 5-7, 7.2-9, 12.001-13.5, or others. For example, the contents can include text, images, videos, sounds, or others. For example, the contents can include meditation rules, pose recommendations, exercise techniques, diet suggestions, or others. The keys are mapped onto the contents, such as in a one-to-one manner, a many-to-one manner, or others. As such, the second device 106 compares the pH reading against the keys and determines whether, if at all, the pH reading corresponds to any of the keys, such as via falling into the range of values, matching by value, or others. Note that such correspondence can be in various ways, such as logically, such as via a Boolean logic, or others. If the pH reading does not correspond to any of the keys, then a default message, such as an error message or others, can be output via the second device 106, such as via the display or others, or a log entry can be locally created via the second device 106 and uploaded from the second device 106 over the second network 108 to the server 110, which may be operated via an administrator client of the system 100, in order to subsequently generate a suitable content for that pH reading and push that suitable content from the server 110 over the second network 108 onto the second device 106. In embodiments where the pH reading includes a plurality of pH readings, the meditation content can be based on averaging the pH readings or using a most current reading.

In block 212a, the second device 106 generates a meditation content based on the pH reading falling into the range of values. For example, the meditation content, which may be interactive or request a user input, can include a meditation technique, an exercise pose, or others. For example, the meditation content can include a text, an image, a video, a sound, or others. The second device 106 generates the meditation content based on accessing, such as via retrieving, reading, copying, or others, the content associated with the key to which the pH reading corresponds.

In block 214a, the second device 106 outputs the mediation content. For example, such output can be via the display, the speaker, the oscillator, or others. The meditation content may be static or dynamic, such as user interactive or others. For example, the meditation content can contain a color range or a color selection menu configured for an interaction with the user. In some embodiments, the second device 106 outputs an image, a text, a vibration, or a sound associated with the meditation content, with the image, the text, the vibration, or the sound being retrieved from a data structure associated, such as via a logical relationship, with various data structures disclosed above or from the various data structures disclosed above.

In block 216a, the second device 106 receives a user input, which may be responsive to the meditation content, such as via the keyboard, the mouse, the microphone, the camera, the touch-enabled display, or others. For example, the user input can include a text, an image, a sound, a gesture, a movement detection, such as shaking or rotating the second device 106 or others, or others. For example, the user input can select a color in the color range or the color selection menu.

In block 218a, the second device 106 take an action responsive to the user input. The action can be any type of computing action, such as generating an input, receiving an input, generating an output, outputting an output, generating a message, communicating with or querying an input device, communicating with or querying an output device, reading a data structure, writing a content to a data structure, editing a content or format of a data structure, deleting a content from a data structure, or others as known to skilled artisans. For example, the action can include outputting, such as via the display, the speaker, or others, another meditation content, whether accessed from the data structure, as explained above or from another data structure. For example, the action can include requesting a biometric from a biometric sensor, whether on the first device 104 or the second device 106 or another device.

As shown in FIG. 2a, the action can include outputting, such as via the display, the speaker, or others, a content via the second device 106, as per block 220a. The action can include writing, such as into an event log or others, the user input into a data structure, such as a file or others, via the second device 106, as per block 222a. The action can include interfacing with a third device, such as a computing device, the server 110, a biometric sensor, such as a heartbeat sensor or others, or others, as per block 224a, in order to synchronize, receive an input from the third device and computationally process the input with the pH reading or other data points stores or accessible to the second device 106, or others.

As shown in FIG. 2a, a method 200a can be performed via the system 100.

In block 202b, the first device 104 is paired with the second device 106 over the first network 102. For example, the first device 104 can be embodied as a wearable device, such as a bracelet, or others, and the second device 106 is embodied as a mobile device, such as a smartphone or others, with the first network 102 being embodied as a PAN, such as based on a Bluetooth protocol or others.

In block 204b, the first device 104 hosts the pH sensor 104.5 that contacts the user, such as the outer surface of the skin of the user or others, and obtains the pH reading of the user.

In block 206b, the first device 104 sends the pH reading to the second device 106 over the first network 106, such as wirelessly or others. The first device 104 can send the pH reading in a raw state or convert into a format suitable for sending to the second device 106.

In block 208b, the second device 106 receives the pH reading from the first device 104, such as wirelessly or others. The second device 106 receives the pH reading in the raw state or in the format suitable for receiving from the first device 104.

In block 210b, the second device 106 determines whether a biometric, such as a pulse value, a heart rate value, a blood pressure value, a sugar level value, a cholesterol value, a weight value, a red or white blood cell count value, or any other body fluid or characteristic value, is locally stored on the second device 106. For example, such determination can occur via the second device 106 querying a local data structure, such as a hash table, a LUT, an array, a linked list, a queue, a deck, a stack, or others, to determine if the local data structure stores the biometric, with the local data structure being searched for the biometric by biometric type, such as a pulse value, a heart rate value, a blood pressure value, or others, and then by date of the biometric and then time of the biometric, with the second device 106 selecting the biometric that is most up to date. In some embodiments, such as when the biometric is not locally stored, the second device 106 determines whether the biometric is available via the server 110. If the biometric is not locally or remotely stored, then block 212b is performed. If the biometric is locally stored, inclusive of retrieval of the biometric from the server 110 when the server 110 avails the biometric to the second device 106, then block 218b is performed.

In block 212b, the second device 106 queries a sensor for the biometric. For example, the sensor can be configured to obtain a pulse value, a heart rate value, a blood pressure value, a sugar level value, a cholesterol value, a weight value, a red or white blood cell count value, or any other body fluid or characteristic value. For example, the first device 104 or the second device 106 can include the sensor or the sensor can be distinct from the first device 104 and the second device 106. For example, the sensor can be positioned non-invasively or invasively, such as via implantation. For example, the sensor can be positioned on the outer surface of the user skin, including hair, skin, and dermis. For example, the sensor can be positioned anywhere on the user, externally or internally, whether invasively or non-invasively, such as within the skin of the user, such as within an inner layer of the skin, or in proximity of or in contact with a nerve of the user, a muscle of the user, an organ of the user or others, on any portion thereof. Note that the second device 106 can be in wired, waveguide, or wireless communication with the sensor 106, such as via a radio communication technique, an optical communication technique, a sound communication technique, an infrared communication technique, or others.

In block 214b, the second device 106 receives the biometric from the sensor responsive to the second device 106 querying the sensor for the biometric. The second device 106 can receive the biometric from the sensor via a radio communication technique, an optical communication technique, a sound communication technique, an infrared communication technique, or others. The sensor can send the biometric to the second device 106 in a raw state or in a converted state suitable for communication to the second device 106. The biometric can include text, images, sounds, or others.

In block 216b, the second device 106 writes the biometric into a data structure that is stored on the second device 106, which can be pushed onto the server 110 for backup or synchronization, which can be based on differencing. Note that if the biometric is received in a raw state from the sensor, then the second device 106 can write the biometric into the data structure in the raw state or convert the biometric from the raw state into a format suitable for writing into the data structure for subsequent writing into the data structure in that format. Similarly, if the biometric is received in the converted state, then if the biometric in the converted state is suitable for writing into the data structure, then the second device 106 writes the biometric in the converted state into the data structure, otherwise, the second device 106 converts the biometric from the raw state into a format suitable for writing into the data structure for subsequent writing into the data structure in that format.

In block 218b, the second device 106 reads the biometric from a data structure.

In block 220b, the second device 106 generates a meditation content based on the pH reading and the biometric. For example, the meditation content, which may be interactive or request a user input, can include a meditation technique, an exercise pose, or others. For example, the meditation content can include a text, an image, a video, a sound, or others.

The second device 106 generates the meditation content based on a hierarchical tree structure, a hash table of hash tables, a LUT of LUTs, or others. For example, if the pH reading is 6 and the biometric is a heart pulse of 95, then the second device 106 identifies a first node of the tree structure corresponding to the pH reading, such as a node for values between 5 and 9 or 6.2 and 8.7 or others, which may be a root node, a parent node, a child node, or others. Then, the second device 106 identifies a second node of the tree structure corresponding to the biometric, such as a node for values between 90 and 100 or 87 and 102, where the first node and the second node may be positioned consecutively. Then, the second device 106 identifies the meditation content associated with the second node, such as in a third node, which may be consecutive to the second node, and accesses the meditation content. Note that although the second device 106 can generate the meditation content based on the pH reading first and then searching for the biometric, this order can be reversed, where the second device 106 generates the meditation content based on the biometric first and then searching for the pH reading. Further, note that the tree can include sub-nodes for the pH reading or the biometric as necessary for further refinement and granularity. For example, a root node for the tree may be 0-14, a first parent node consecutive to the root node may be 0-6.9, and a second parent node consecutive to the root node may be 7.1 to 14, a first child node to the first parent node may be 0-3 and a second child node to the first parent may be 3.1 to 6.9 and so forth. Moreover, a node in the tree may correspond to a range of values or individual values.

In block 222b, the second device 106 outputs the mediation content. For example, such output can be via the display, the speaker, the oscillator, or others. The meditation content may be static or dynamic, such as user interactive or others. For example, the meditation content can contain a color range or a color selection menu configured for an interaction with the user. In some embodiments, the second device 106 outputs an image, a text, a vibration, or a sound associated with the meditation content, with the image, the text, the vibration, or the sound being retrieved from a data structure associated, such as via a logical relationship, with various data structures disclosed above or from the various data structures disclosed above.

In block 224b, the second device 106 receives a user input, which may be responsive to the meditation content, such as via the keyboard, the mouse, the microphone, the camera, the touch-enabled display, or others. For example, the user input can include a text, an image, a sound, a gesture, a movement detection, such as shaking or rotating the second device 106 or others, or others. For example, the user input can select a color in the color range or the color selection menu.

In block 226b, the second device 106 take an action responsive to the user input. The action can be any type of computing action, such as generating an input, receiving an input, generating an output, outputting an output, generating a message, communicating with or querying an input device, communicating with or querying an output device, reading a data structure, writing a content to a data structure, editing a content or format of a data structure, deleting a content from a data structure, or others as known to skilled artisans. For example, the action can include outputting, such as via the display, the speaker, or others, another meditation content, whether accessed from the data structure, as explained above or from another data structure. For example, the action can include requesting a biometric from a biometric sensor, whether on the first device 104 or the second device 106 or another device.

As shown in FIG. 2b, the action can include outputting, such as via the display, the speaker, or others, a content via the second device 106, as per block 228b. The action can include writing, such as into an event log or others, the user input into a data structure, such as a file or others, via the second device 106, as per block 230b. The action can include interfacing with a third device, such as a computing device, the server 110, a biometric sensor, an antenna, such as a heartbeat sensor or others, or others, as per block 232b, in order to synchronize, receive an input from the third device and computationally process the input with the pH reading or other data points stores or accessible to the second device 106, or others.

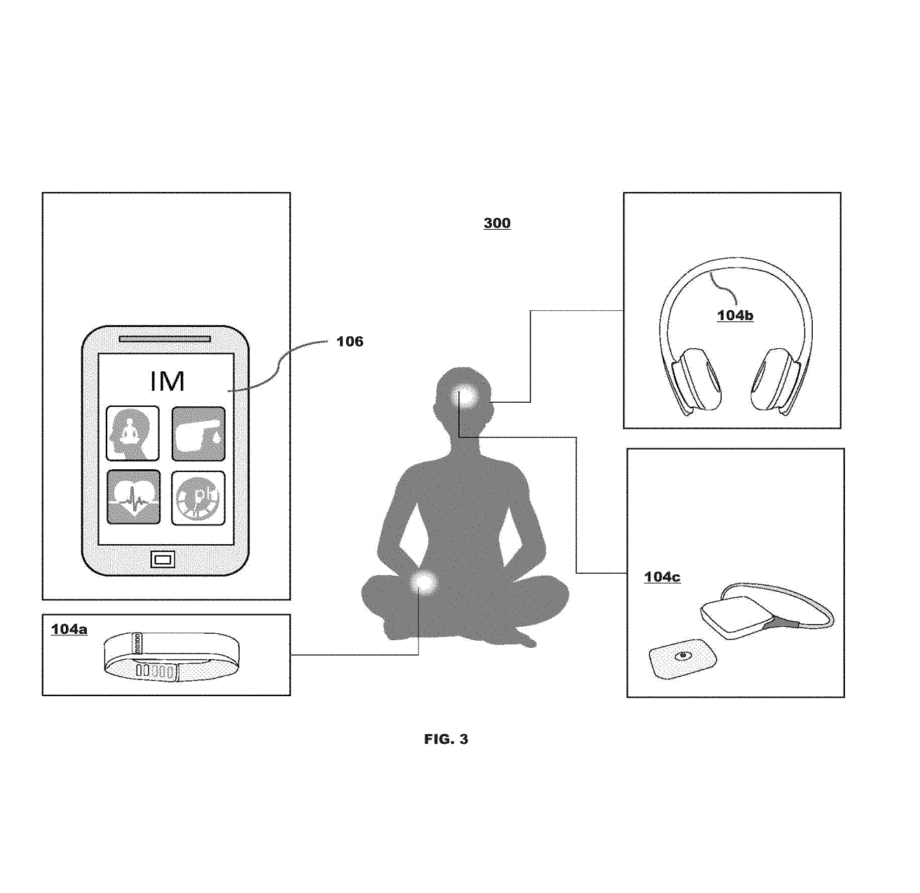

FIG. 3 shows a diagram of an embodiment of a user meditating and employing a mobile device and a wearable device according to this disclosure. In particular, a user 300 uses the first device 104 and the second device 106 to meditate. As shown, the second device 106 is embodied as a smartphone running a mobile app depicting a graphical user interface with a plurality of action icons that are concurrently displayed in order to receive a user input, such as a touch input, a sound input, an image input, a shake input, or others. When activated, the action icons lead to different menus or pages within the mobile for a presentation of the meditation content and a reception of the user input, as disclosed herein. For example, the pages can present a plurality of meditation contents, where the icons correspond to the pages in a one-to-one manner, where the pages correspond to the meditation contents in a one-to-one manner.

The first device 104 is embodied in multiple forms, such as a wristband or bracelet 104a, a headphone 104b, or a headband or skin patch 104c. For example, the wristband or the bracelet 104a hosts, whether on a flexible or rigid portion thereof, the pH sensor or the sensor for the biometric, as disclosed herein, whether externally or internally, such as via fastening, adhering, mating, or others. For example, the headphone 104b, whether wired or wireless, whether circum-aural, supra-aural, open, semi-open, semi-closed, closed back, ear-fitting, or a headset, hosts the pH sensor or the sensor for the biometric, as disclosed herein. Note that the headphone 104 can include a headband, or a cord, or an earpiece, such as an ear cup, an ear bud, an ear pad, an ear phone, an in-ear piece, or a pivoting earphone, any of which can host the pH sensor or the sensor for the biometric, whether externally or internally, such as via fastening, adhering, mating, or others. In some embodiments, the headphone 104b includes a noise-cancelling hardware or software. For example, the headband or the skin patch 104 hosts, whether on a flexible or rigid portion thereof, the pH sensor or the sensor for the biometric, as disclosed herein, whether externally or internally, such as via fastening, adhering, mating, or others. Note that the wristband or the bracelet 104a, the headphone 104b, and the headband or skin patch 104c can communicate with each other, whether in a wired or wireless manner, such as via a radio communication technique, an optical communication technique, an infrared communication technique, a sound communication technique, or others. In some embodiments, whether additional or alternative to the headphone 104b, the second device 104 can be embodied as a hearing aid positioned within an ear of the user.

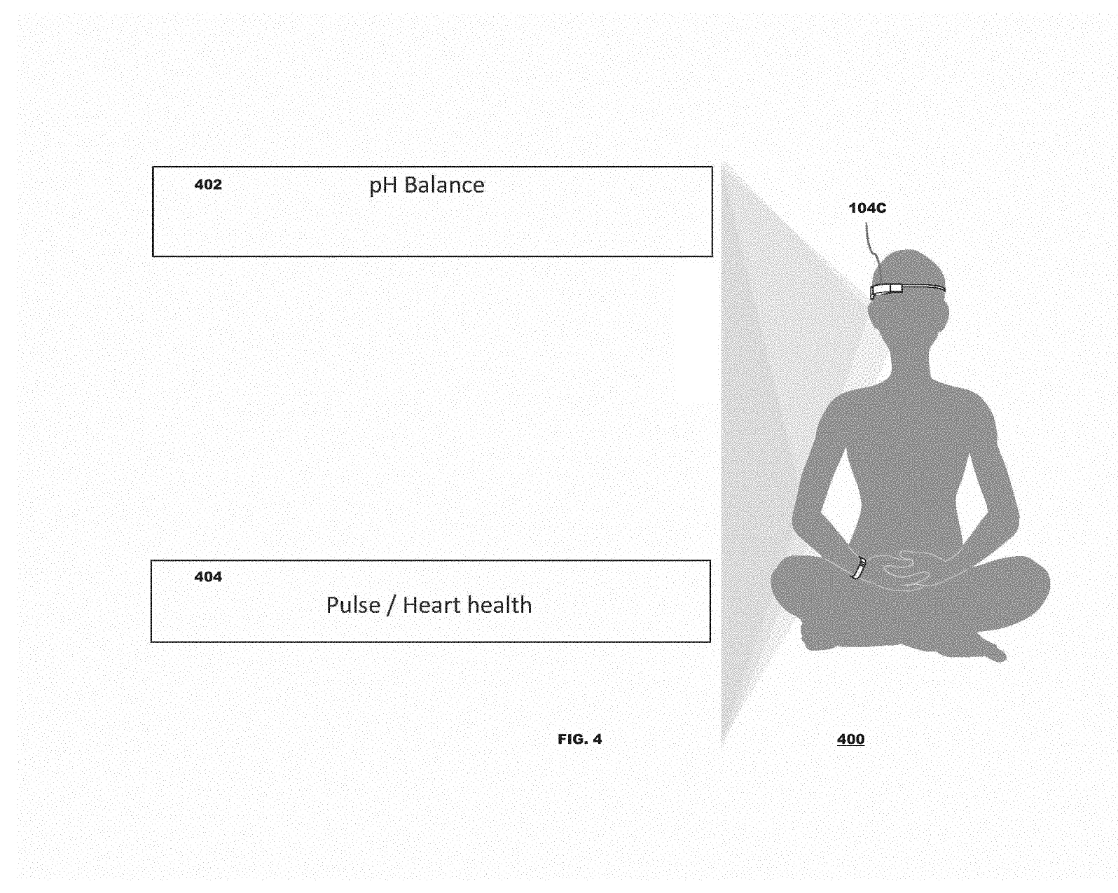

FIG. 4 shows a diagram of an embodiment of a user meditating and employing a mobile device and a wearable device, where the wearable device includes a pH sensor and a heart sensor according to this disclosure. In particular, a user 400 is performing a meditation technique while wearing the wristband or the bracelet 104a and the headband or skin patch 104c. Note that the wristband or the bracelet 104a or the headband or skin patch 104c contain a pH sensor 402 or a heart sensor 404 in any permutation combinatorics thereof. For example, the wristband or the bracelet 104a can include the pH sensor 402 or the heart sensor 404 or both. For example, the headband or skin patch 104c can include the pH sensor 402 or the heart sensor 404 or both. For example, the wristband or the bracelet 104a or the headband or skin patch 104c can wirelessly communicate with each other over the first network 102, such as directly over a PAN.

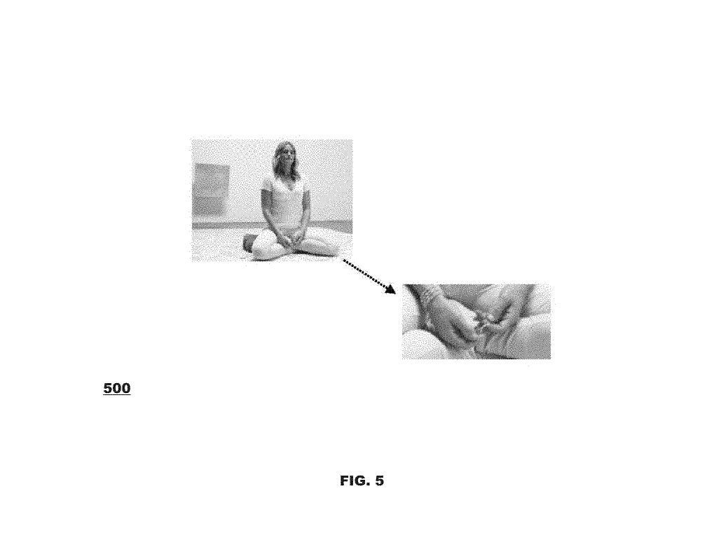

FIG. 5 shows a diagram of an embodiment of a user meditating and employing a tactile device according to this disclosure. In particular, a user 500 performs a meditation technique, while engaging with a meditation device in a tactile manner, as disclosed herein. The meditation device includes a loop, a plurality of knots or beads knotably or mountably stationed along the loop, and a member that is mounted onto the loop and that travels along the meditation device over the knots or beads based on the user 500 moving the member, which can mark a repetition of a meditation thought. The meditation device is explained in further detail below.

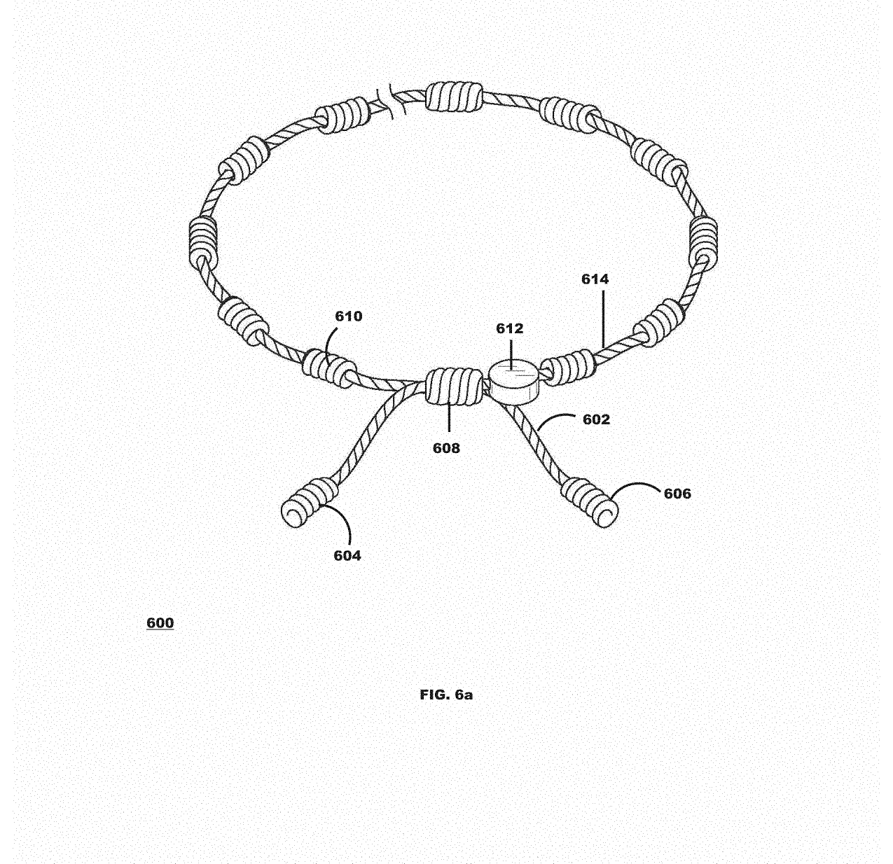

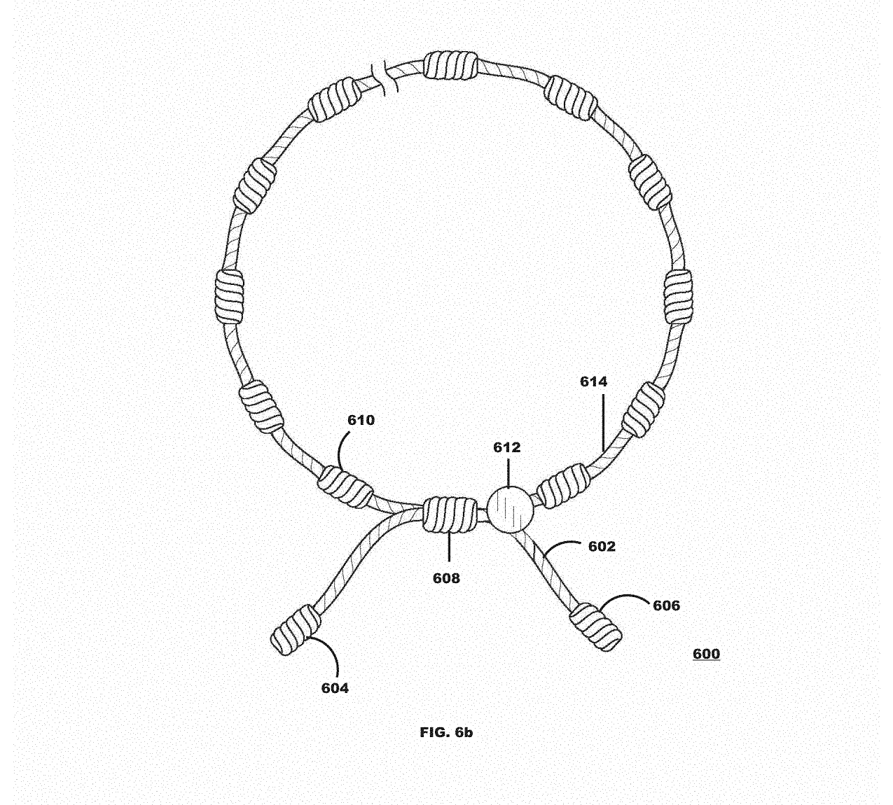

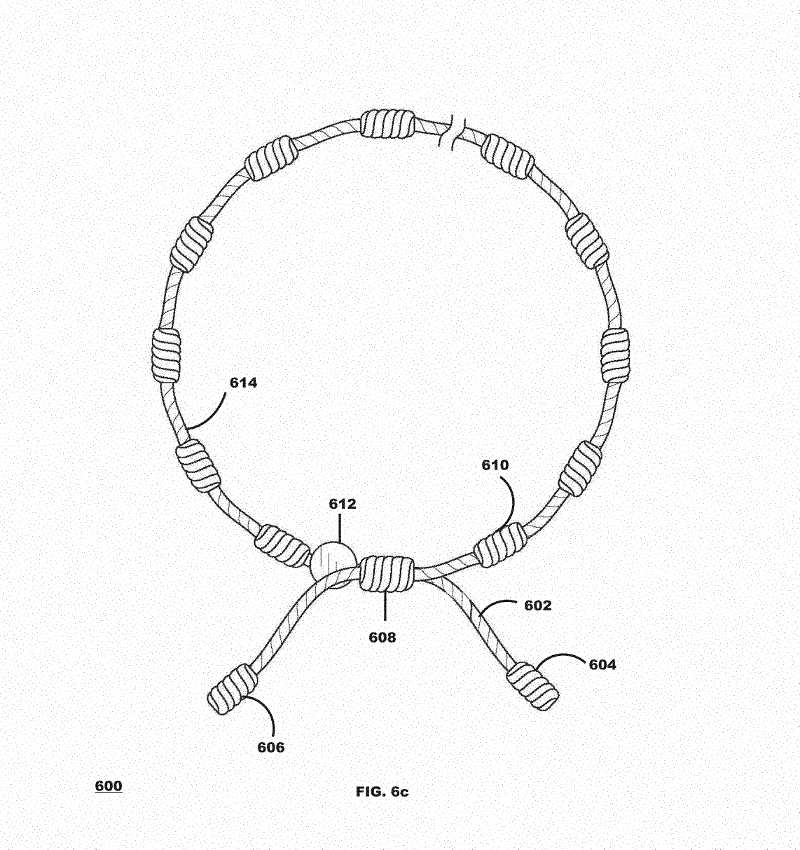

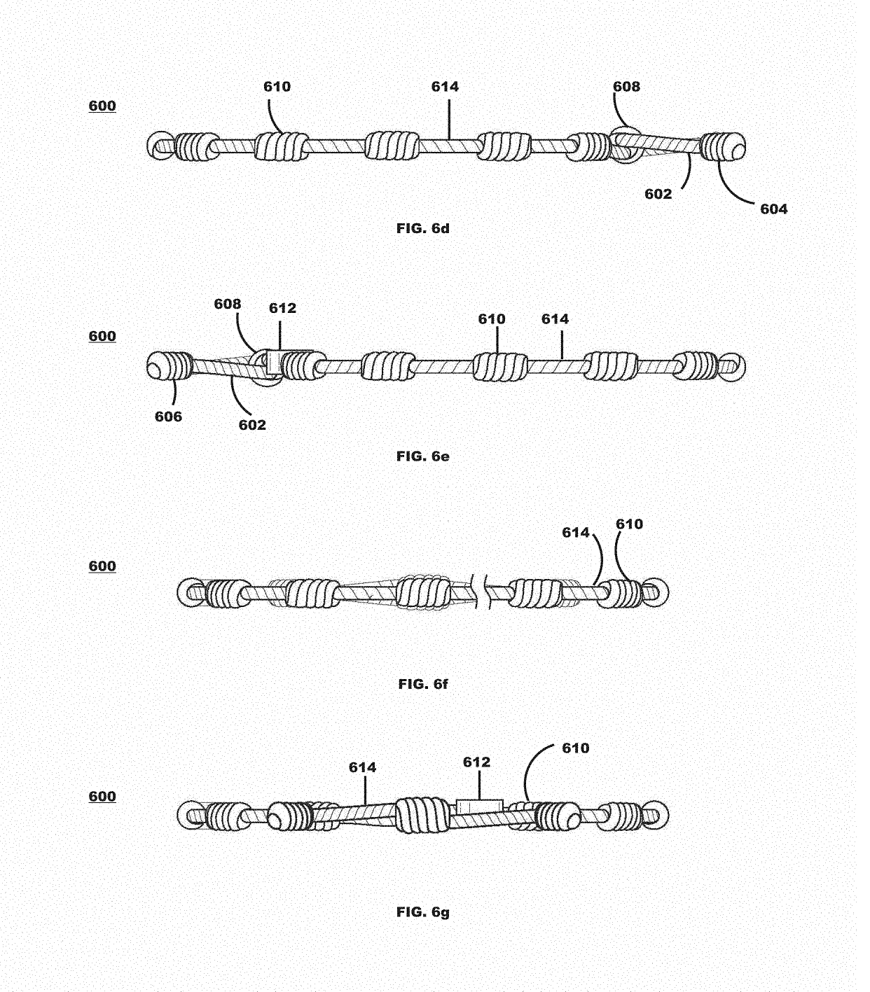

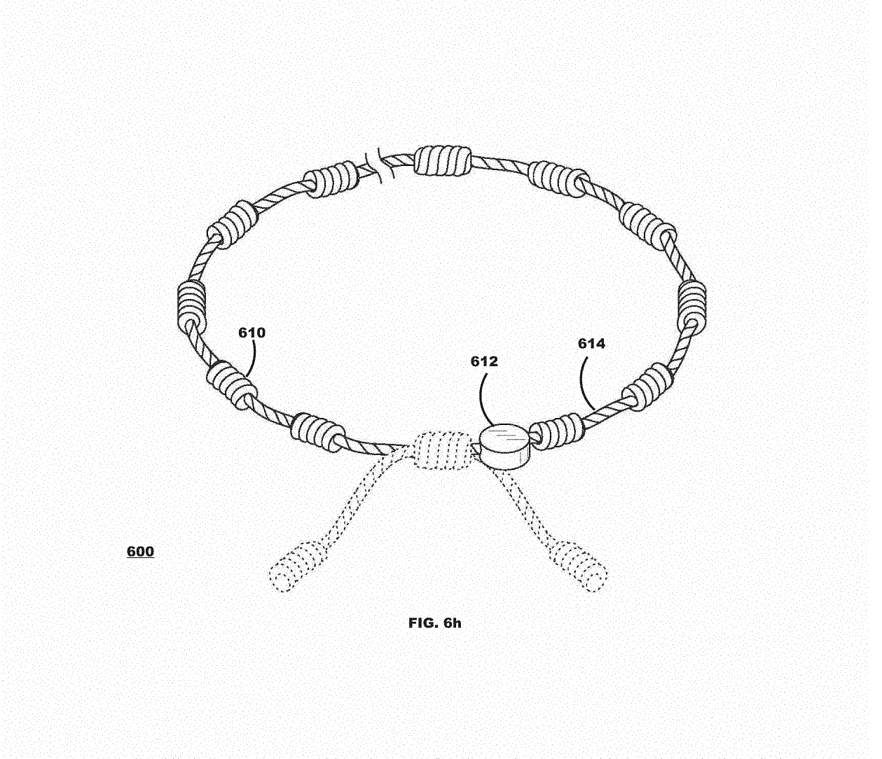

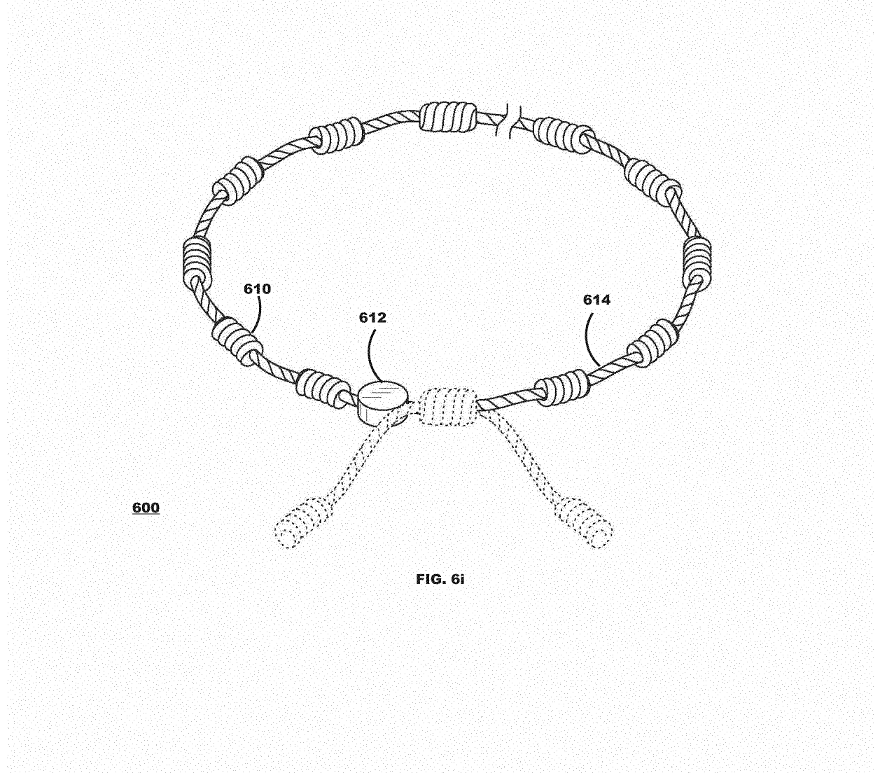

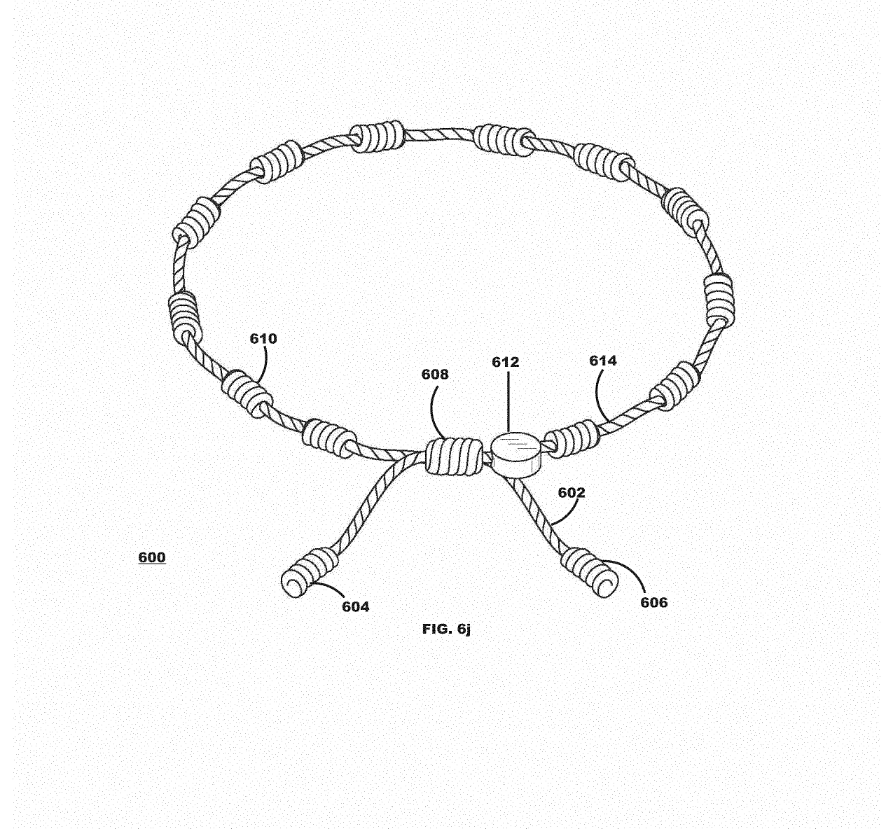

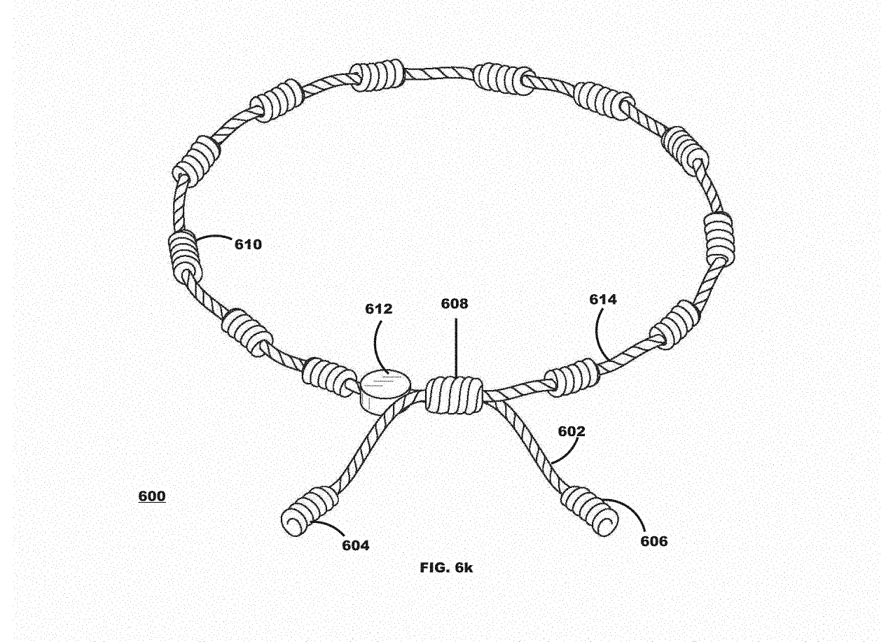

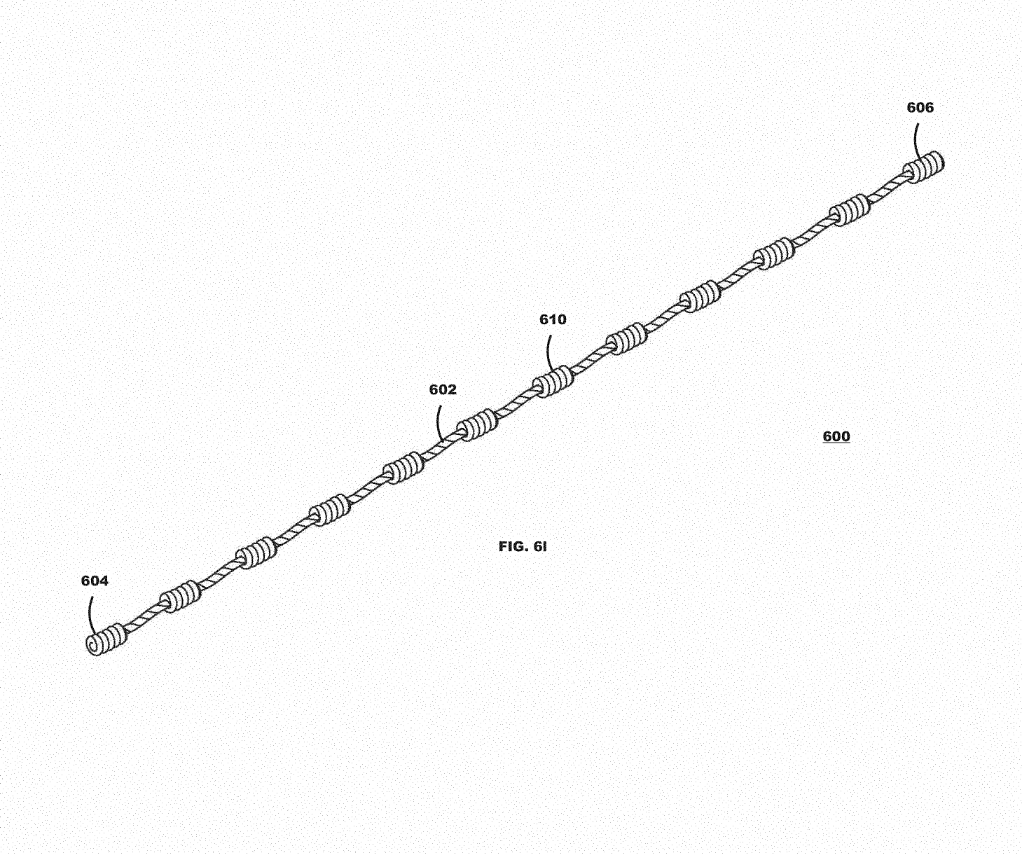

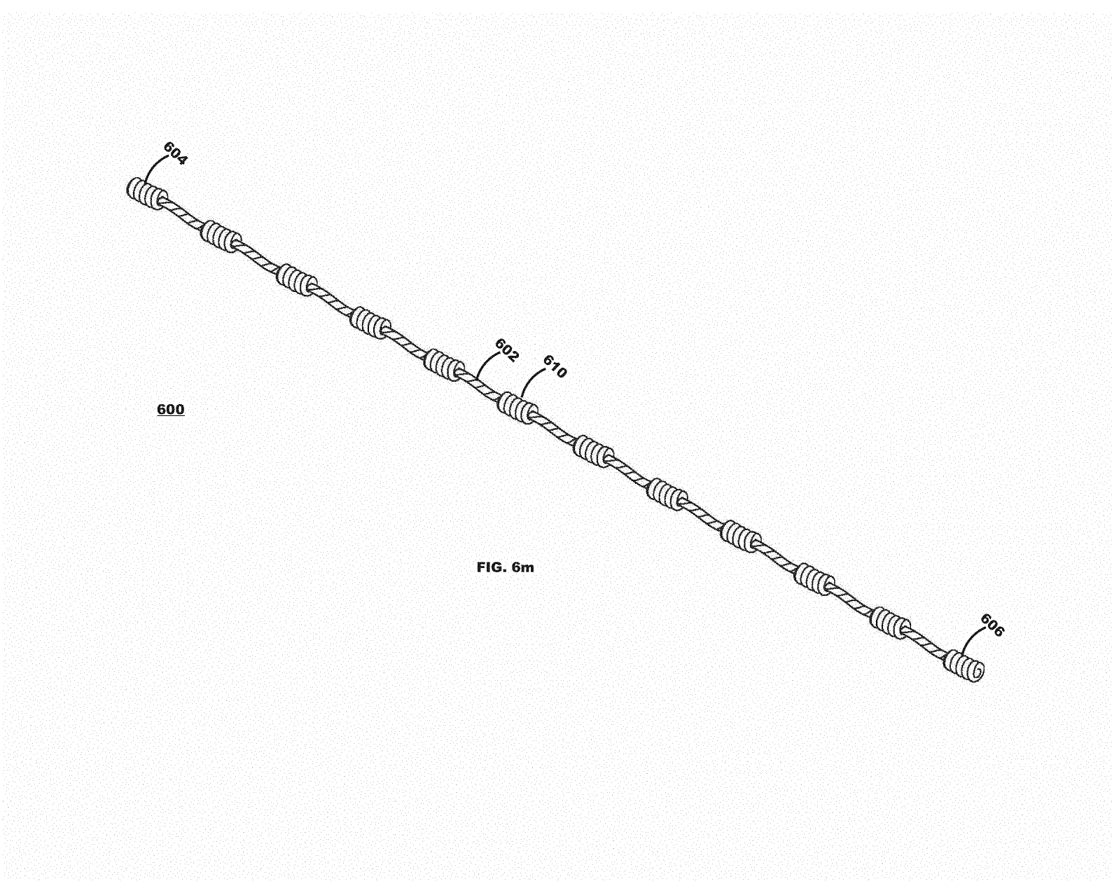

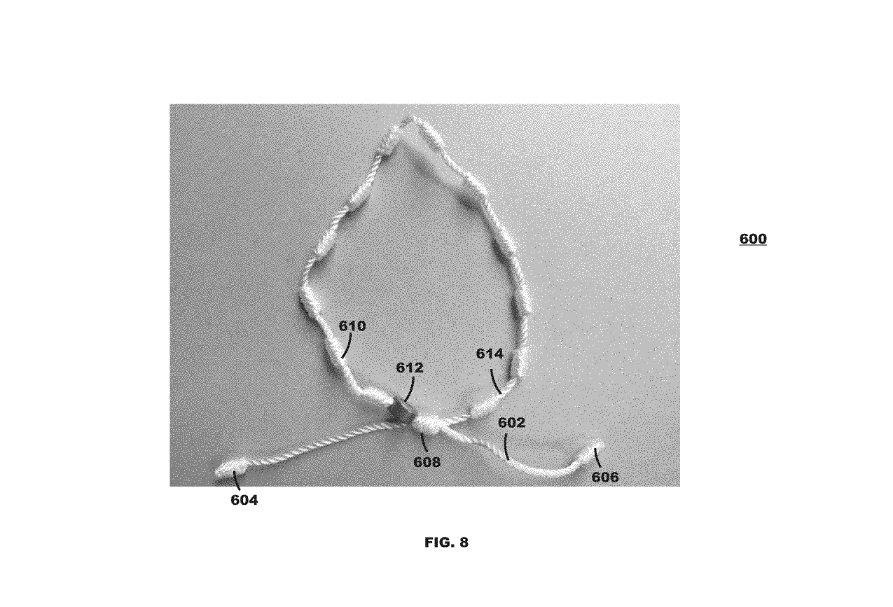

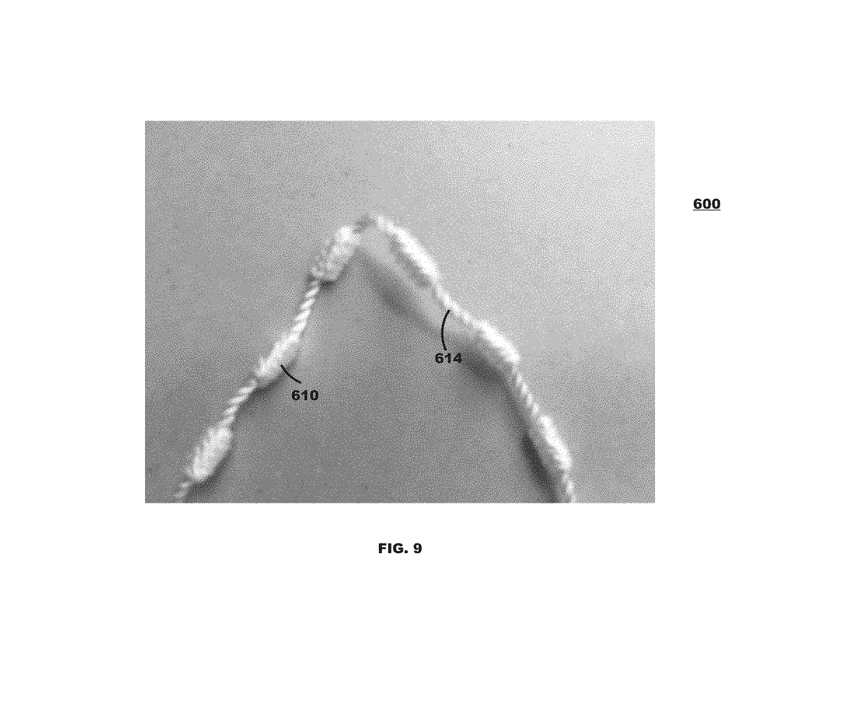

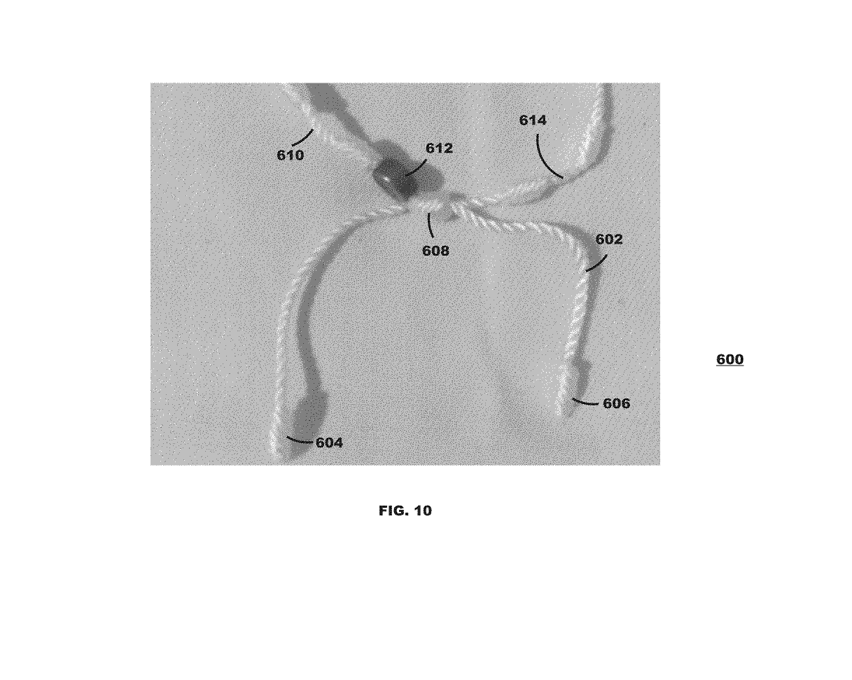

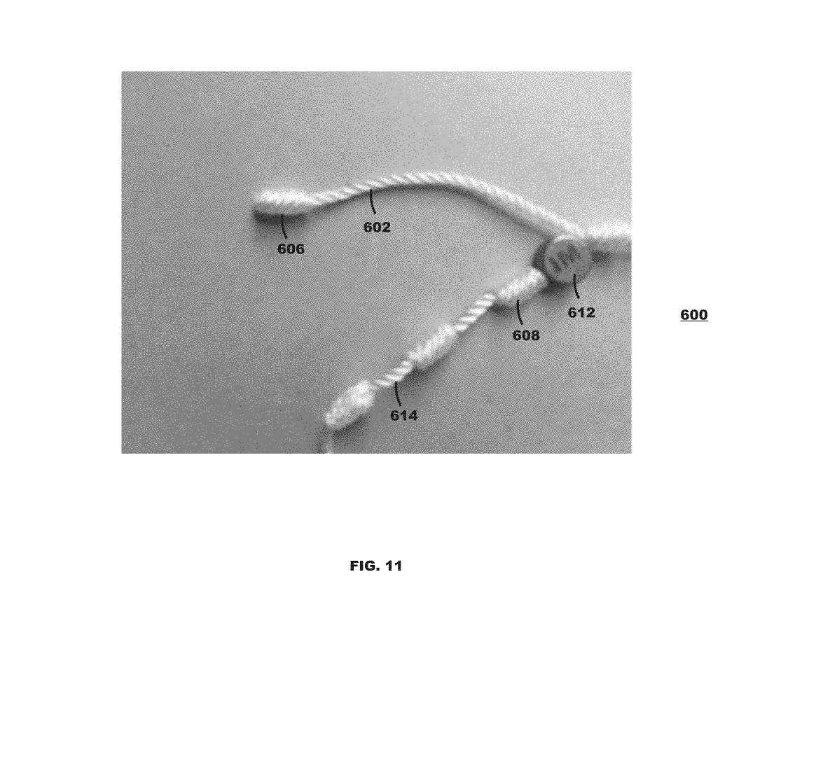

FIGS. 6a-6m show a diagram of an embodiment of a tactile bracelet according to this disclosure. FIGS. 8-11 show a diagram of an embodiment of a tactile bracelet according to this disclosure. In particular, a tactile bracelet 600 includes a cord 602 having a first end portion 604 and a second end portion 606, both of which are extend helically. The cord 602 can include a fabric, a textile, a plastic, a metal, or others. For example, the cord 602 includes a strand of flexible material. The cord 602 can include a braid, a chain, a belt, a hook, or others. The cord 602 can include a plurality of strands or materials. The cord 602 may be a triple braided line. The cord 602 may be of any material, including nylon, cotton, hemp, leather, or any other material that may be used to form the bracelet 600. The cord 602 may be of a same color or include a plurality of consecutive segments that are colored differently or visually distinct from each other in other ways. For example, the cord 602 can include a blue segment, a purple segment, a yellow segment, all consecutive to each other. For example, the cord 602 can include a first hatched segment and a second hatched segment, all consecutive to each other, yet hatched differently from each other. The cord 602 is tied in a knot 608 such that a loop 614 is formed.

The loop 614 includes a plurality of knots 610 stationed along the loop 614 and spaced apart from each other, whether in an equidistant manner or non-equidistant manner, such as a prayer rope device. The 610 knots, in being regularly spaced, may be substantially equally spaced. In being substantially equally spaced, this spacing may have a difference of a few millimeters, such as between 1 and 20 millimeters. The knots 610 may have a same number of loops or portions that extend radially along the cord 602. Although the knot 608 is helical, the knot 608 can be non-helical. Each of the knots 610 extending along the loop of the bracelet may have a certain length, width, and height, such as a quarter of an inch. Alternative lengths, widths, or heights of the knots 610 may be utilized, whether equal or non-equal to each other such that the knots 610 can be identical or not identical in shape or volume. Each of the knots may have a substantially similar length or have different lengths. In an embodiment, each of the knots 610 may have an identical number of turns. Alternative knot configurations may be utilized, as well. Although the knots 610 are helical, at least one of the knots 610 can be non-helical. For example, the loop 614 can include twelve knots 610, with each knot corresponding to an hour or a month or others, however, any number of the knots 610 can be used, whether greater or lesser than twelve. In some embodiments, the loop 614 hosts a plurality of beads, similar to a Rosary or Misbaha device.

The tactile bracelet 600 further includes a member 612, which is shaped cylindrically, but can be shaped differently, such as a polygon, a wedge, a sphere, an ovoid, a pyramid, a disc, or any other shape. The member 612 is rigid, but can be flexible. The member 612 defines an internal channel therein such that the member 612 is mounted onto the loop 614 via the internal channel. The internal channel is rectilinear, but can be shaped differently, such as via being arcuate, sinusoidal, or others. The member 612 can include plastic, metal, rubber, wood, ceramic, stone, or others. Therefore, the member 612 can travel along the loop 614 longitudinally via the internal channel and pass over the knots 610 via the channel. However, the knot 608 limits the member 612 from traveling past the knot 608 such that the member 612 is unable to fully travel along the cord 602. However, in embodiments, without the knot 608, the member 612 can travel along the cord 602 multiple times around. In some embodiments, the member 612 is visually distinct, such as via color or hatching or others, from the cord 602, the loop 614, the knots 610, the knot 608, the end portions 604, 606, or others.

The first device 104 or the second device 106 can be embodied as the tactile bracelet. The tactile bracelet 600 can host the pH sensor or the sensor for the biometric, whether on the cord 602, the end portions 604 or 606, the knot 608, the loop 614, the knots 610, the member 612 or others. For example, the pH sensor or the sensor for the biometric can be stationed on the knots 610 or between the knots 610.

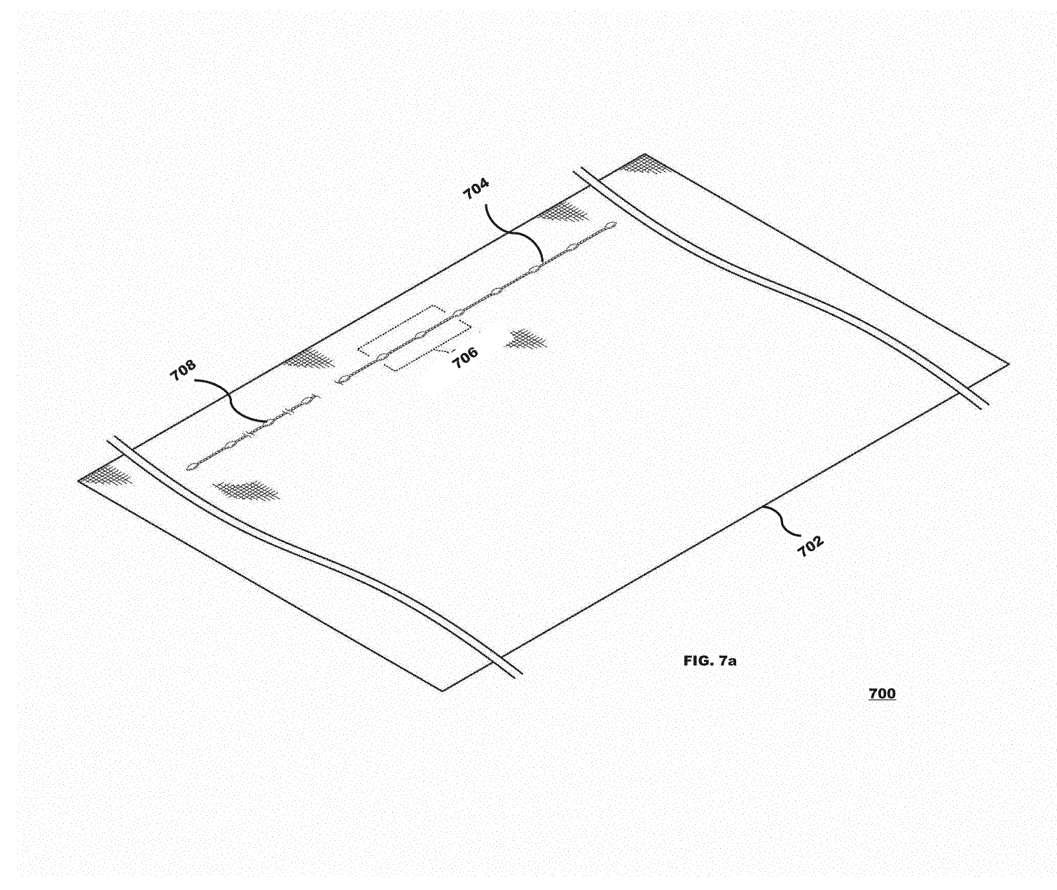

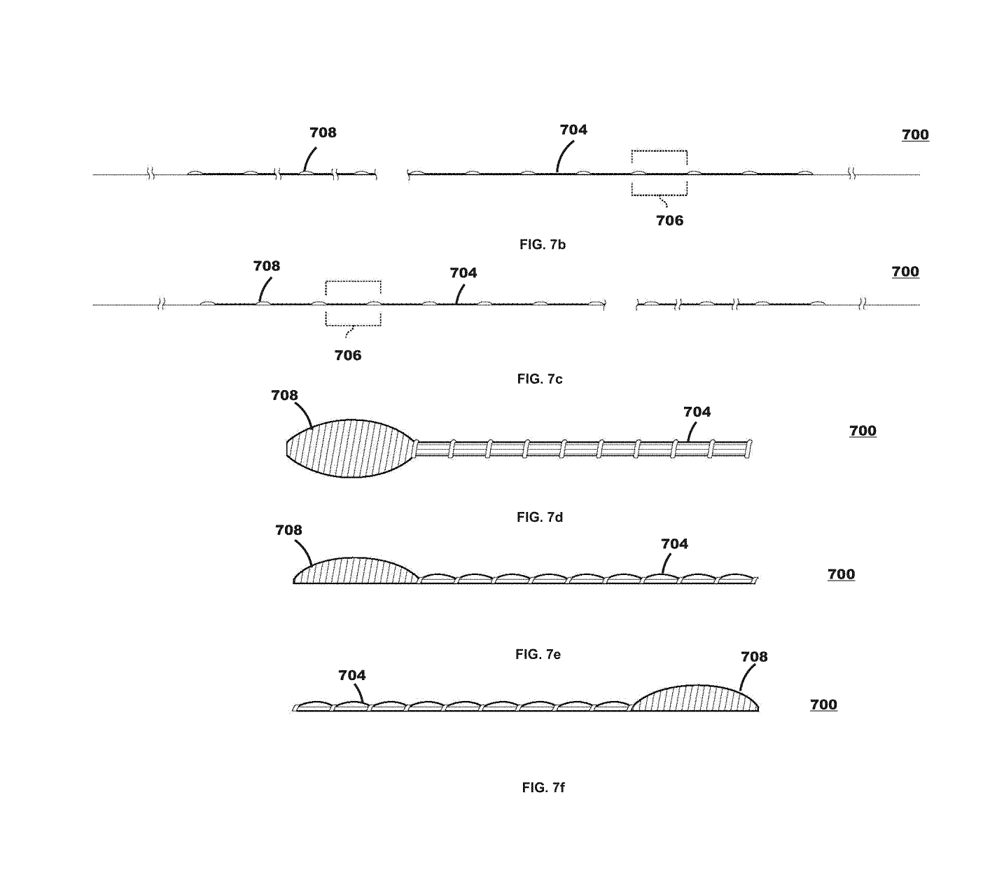

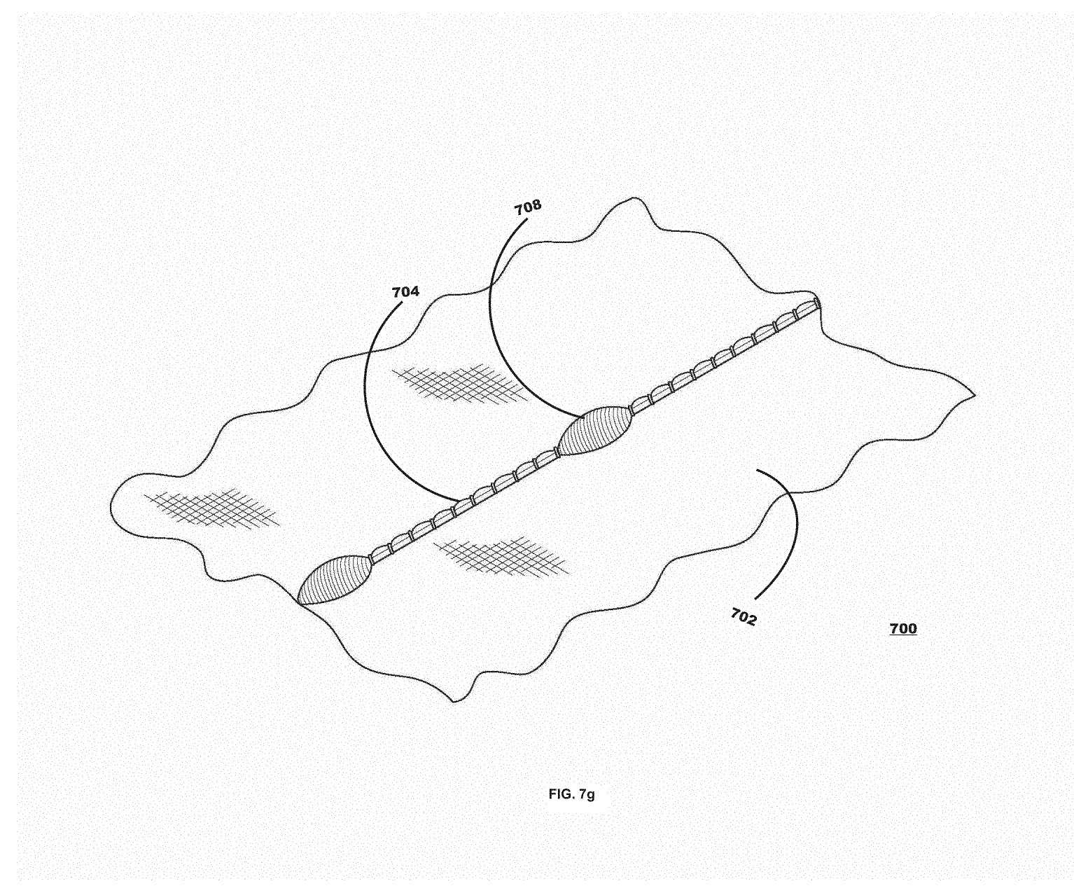

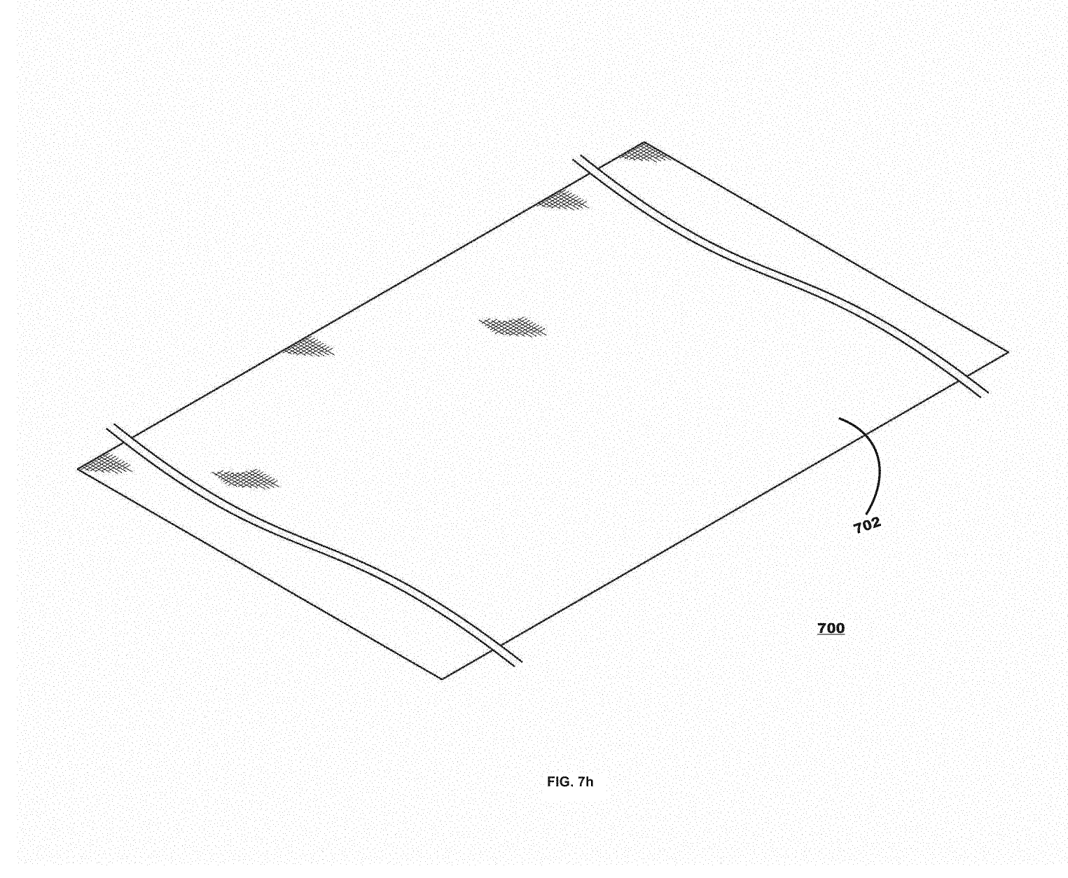

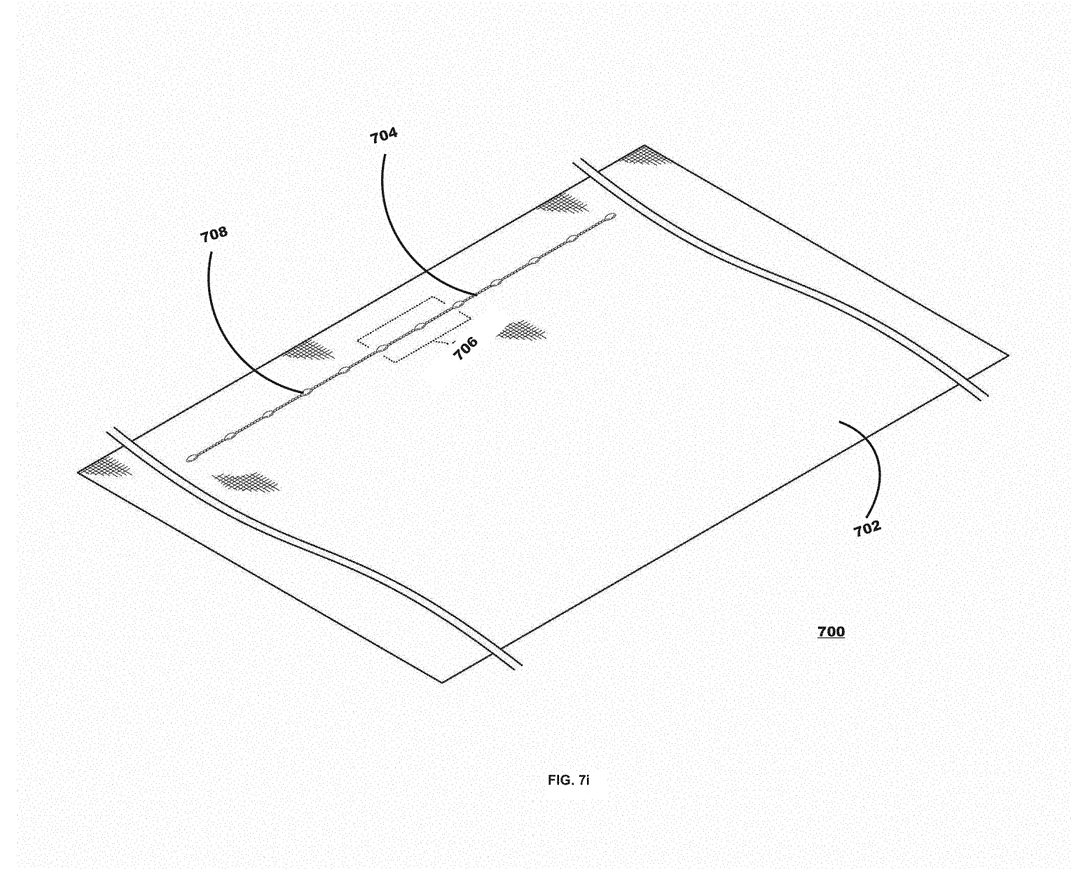

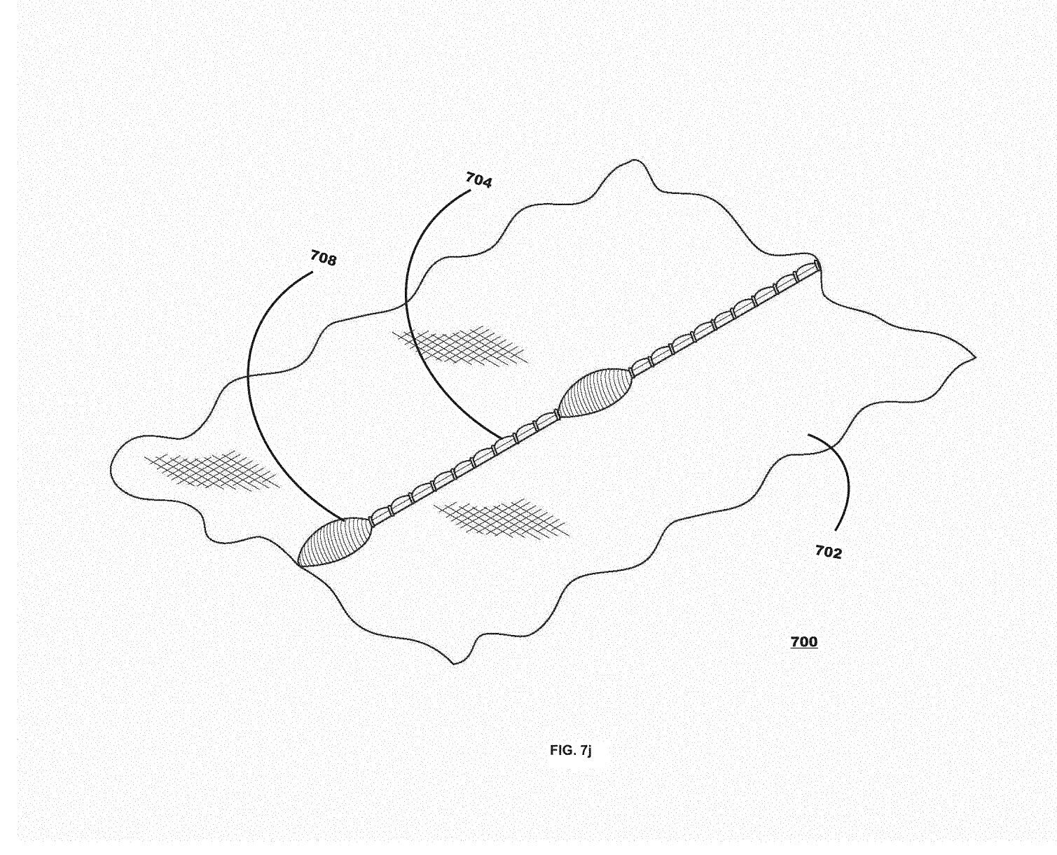

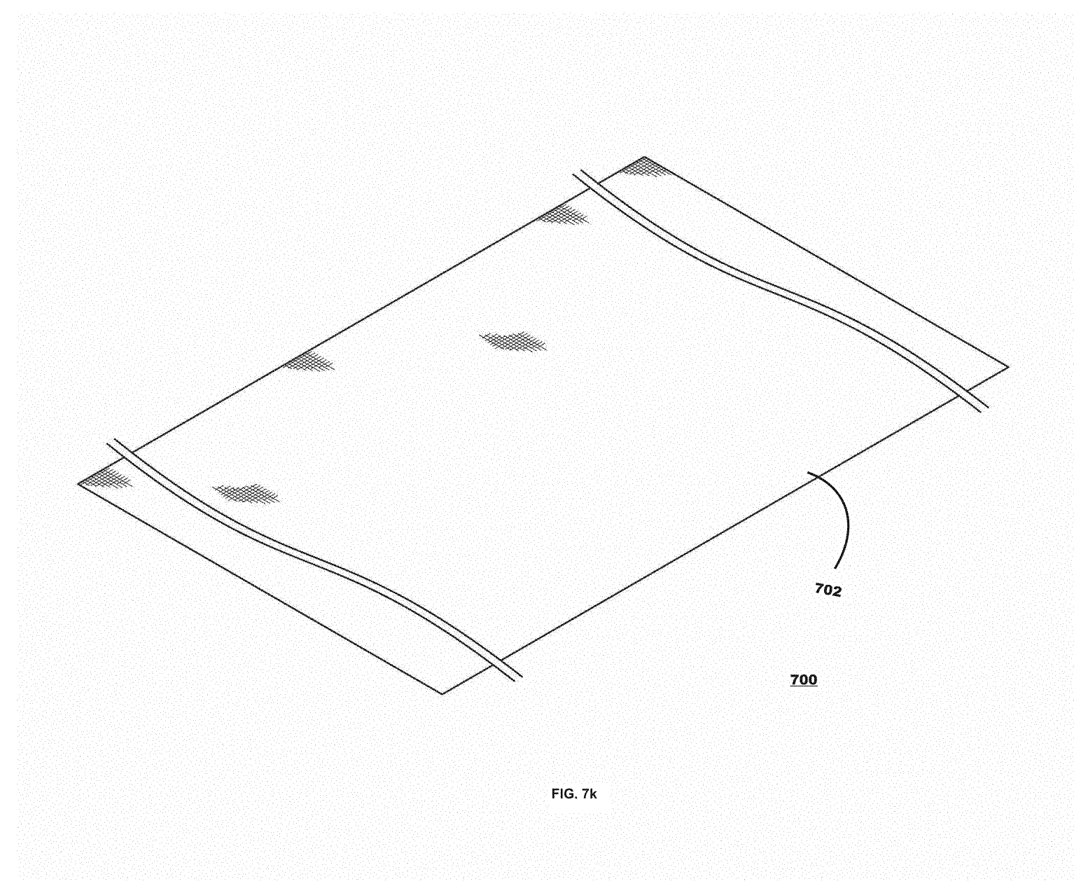

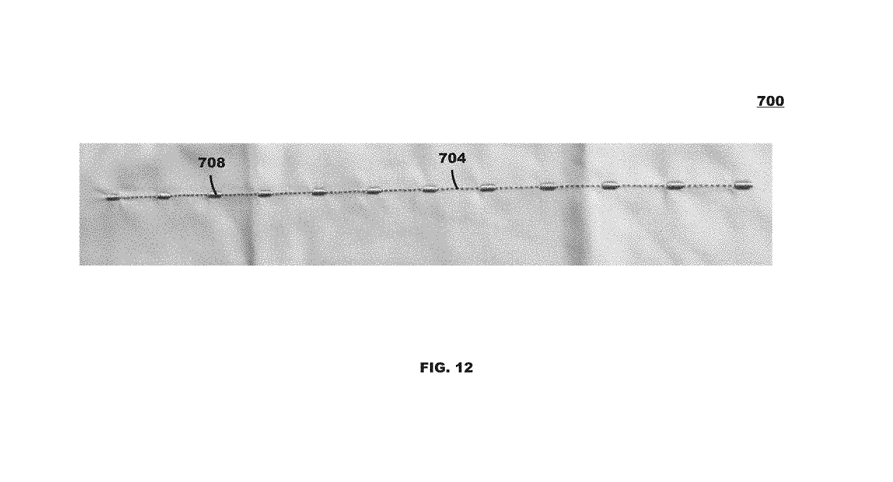

FIGS. 7a-7k show a diagram of an embodiment of a fabric including a linear sequence of features according to this disclosure. FIG. 12 shows a diagram of an embodiment of a fabric including a linear sequence of features according to this disclosure. In particular, a fabric 700, such as a cloth, includes a body 702 which has a side that hosts the cord 602 as the cord 602 extends in a rectilinear manner, although other forms of extension are possible, such as arcuate, sinusoidal, pulsating, zigzag, closed shaped, or others. The body 702 can be embodied as a carpet, a rug, a garment, a wearable, a bedding item, or others. The cord 602 hosts a linear portion 704 that has a plurality of projections 708 extend away from the body 702 for tactile purposes. The linear portion 704 and the projections 708 are tactile and are similar to the tactile bracelet 600 in a non-loop configuration. The fabric 700 can be embodied as the first device 104 or the second device 106 and can thereby include the pH sensor or the sensor for the biometric, as disclosed herein.

The fabric 700 may be stitched, embroidered, embossed, or otherwise formed onto a cloth or other material so that the user may feel the cord 602 with his or her fingers for use in meditation. The fabric 700 may be any size and formed of any material, including a pillow case, blanket, cushion, pad, and so on. For example, the fabric 700 may be formed of cotton, nylon, blended material, and so forth. In an embodiment, rather than being a cloth, the fabric 700 may be semi-rigid or rigid.

In some embodiments, rather than raising the projections 708 in the fabric 702, portions of material may be removed to create features that are arranged in a similar manner, such as substantially equally spaced with a guide feature between the features. In removing the material, the material may be cut, stamped, cut, laser cut, laser etched, or otherwise removed.

In some embodiments, a large fabric 702 may be used to host a plurality of cords 602, and sections of the large fabric 702 may be cut out of the large fabric 702 to form thinner portions of material. Alternatively, the large fabric 702 may have a single cord 602 disposed thereon. Depending on the large fabric 702, the cord 602 may be disposed near an edge so that a user may kneel on the large fabric 702 and the cord 602 may be positioned in front of the user for touching during meditation.

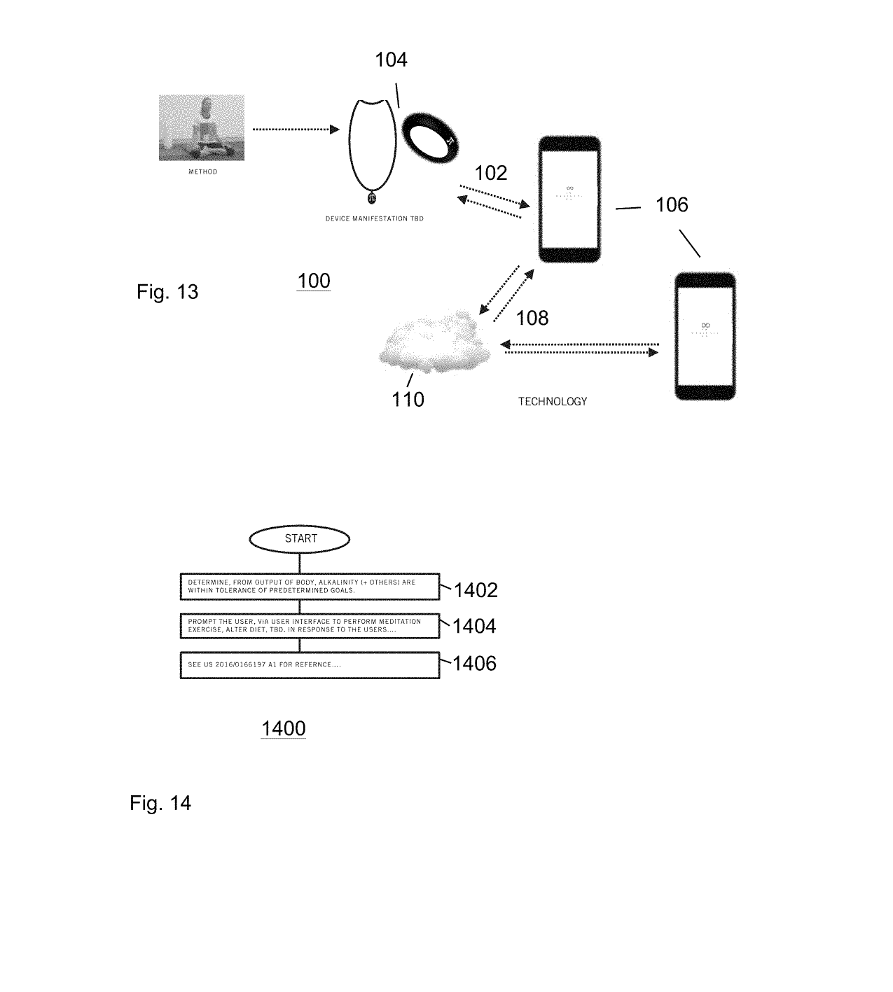

FIG. 13 shows a diagram of an embodiment of a wearable device obtaining a pH sensor reading and communicating with a mobile device in communication with a server according to this disclosure. In particular, in light of FIGS. 1-12, the system 100 is used in context of the user meditating while using the bracelet 600, the fabric 700, and the system 100 to sense the pH reading and the sensor for the biometric, as disclosed herein.

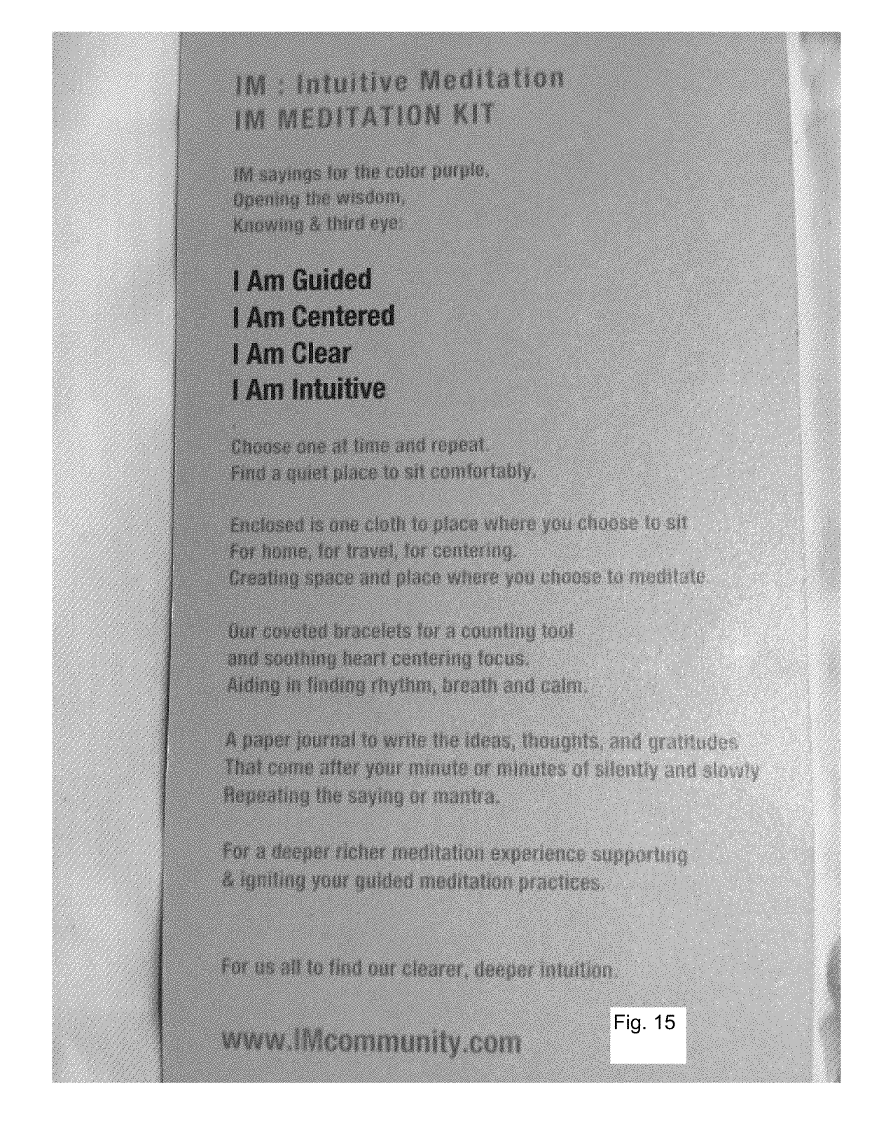

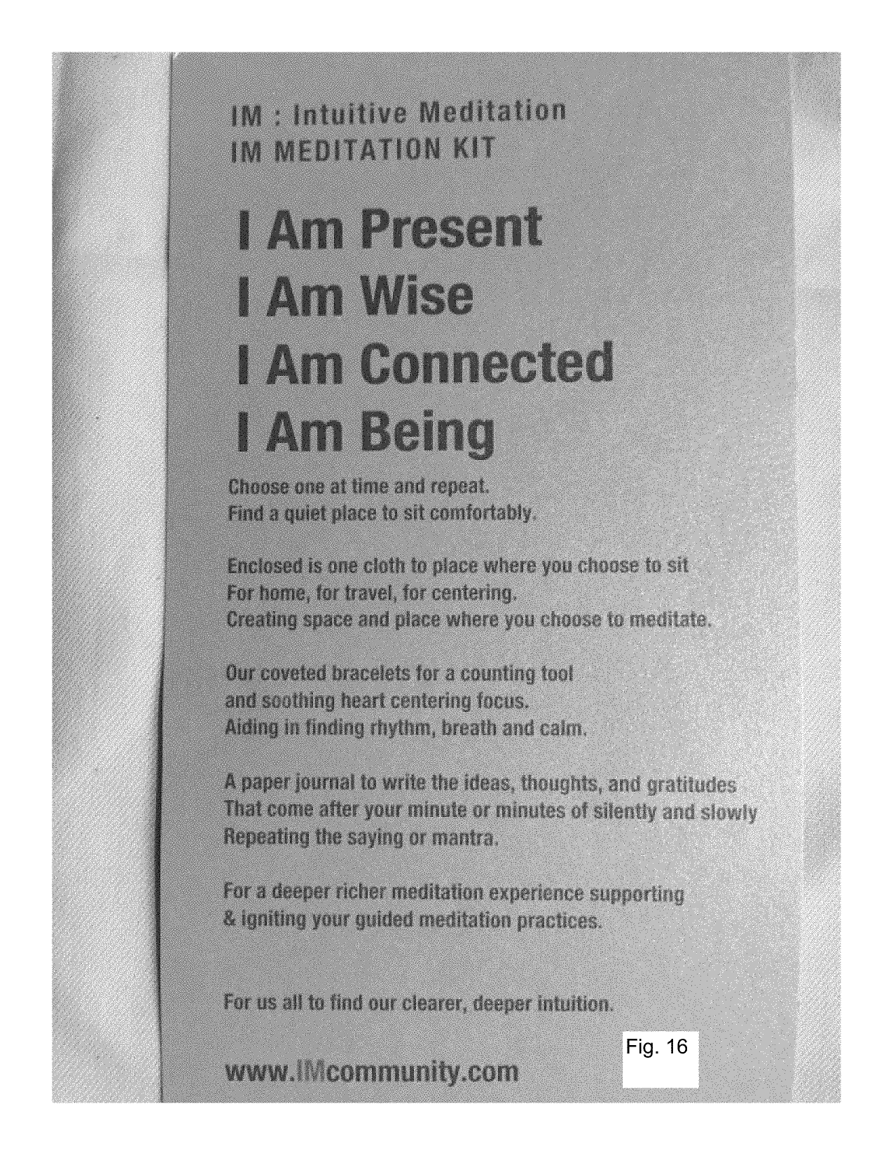

FIG. 14 shows a flowchart of an embodiment of a method of meditation according to this disclosure. In particular, a method 1400 can be performed via the system 100.

In block 1402, the first device 104 or the second device 106 can determine whether the pH reading, which may include an alkalinity value, is within a tolerance of a predetermined goal, whether locally or remotely stored. Note that other bio sensors can be used, whether additionally or alternatively.

In block 1404, the first device 104 or the second device 106 can prompt the user to perform an action, such as exercise, alter diet, or others, in response to a user input responsive to the pH reading being within the tolerance.

In block 1406, the first device 104 or the second device 106 can take a computing action, as disclosed herein, such as input an input, output an output, write a datum into a data structure, query an input, output, or processing device, or others.

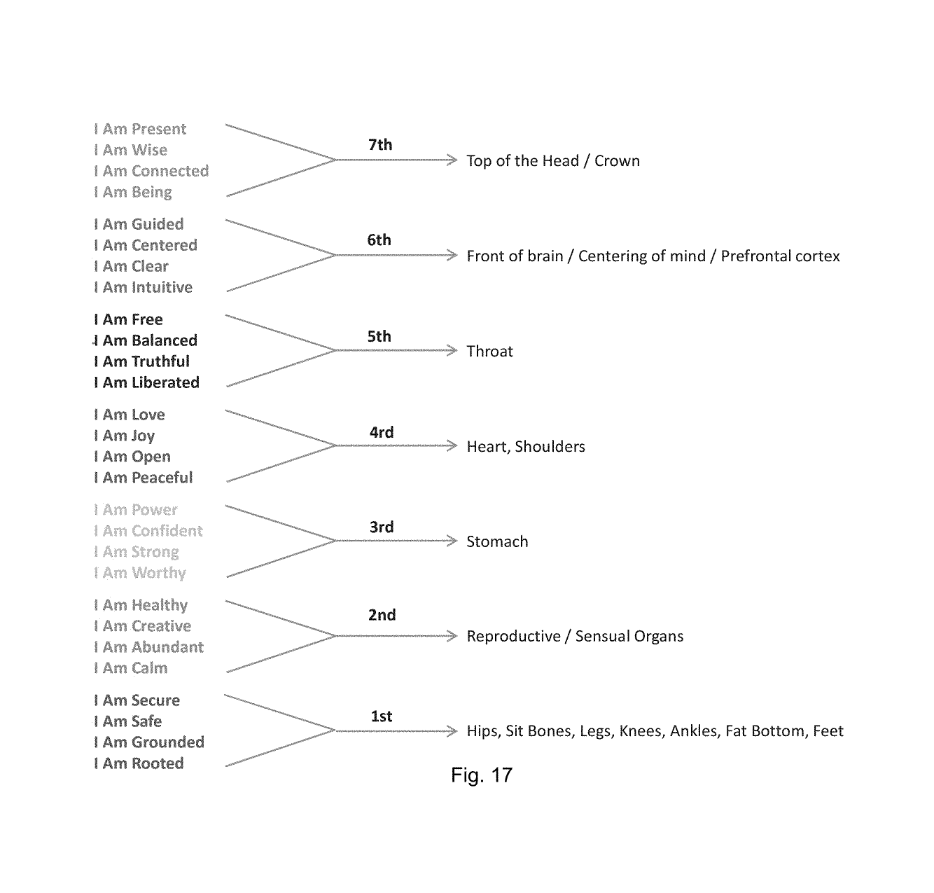

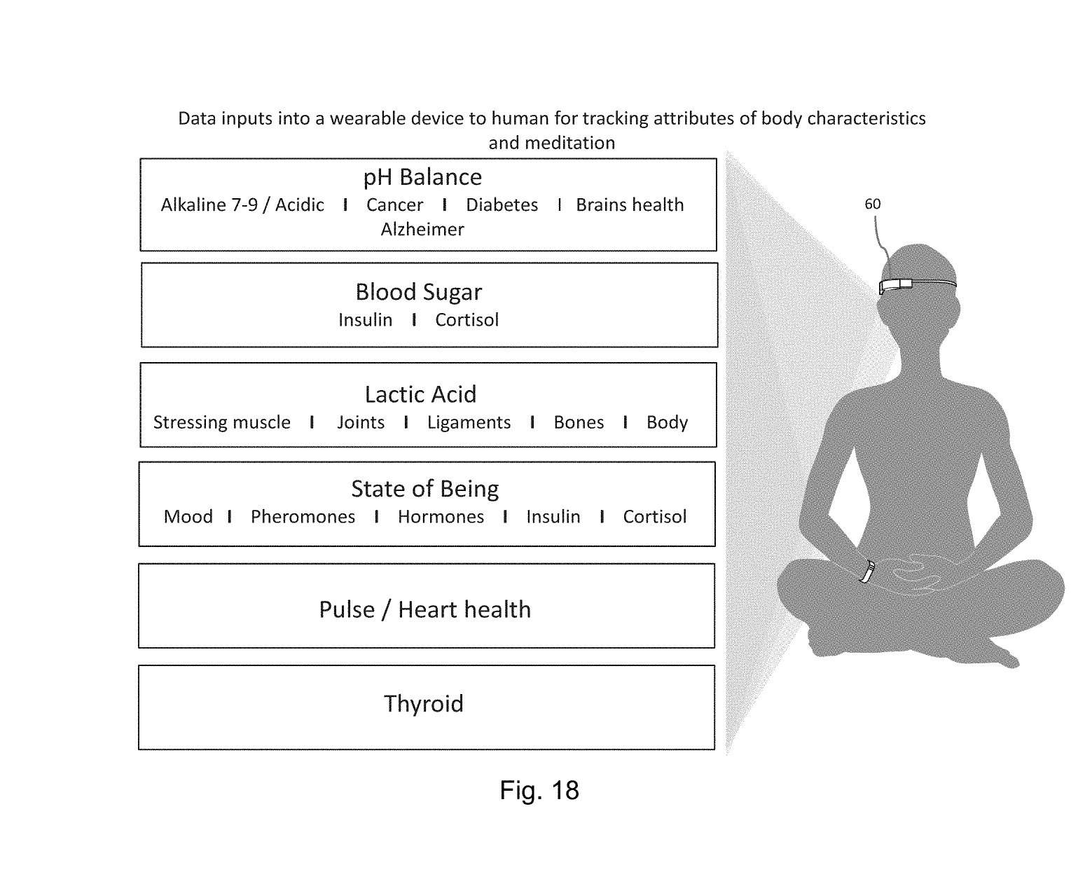

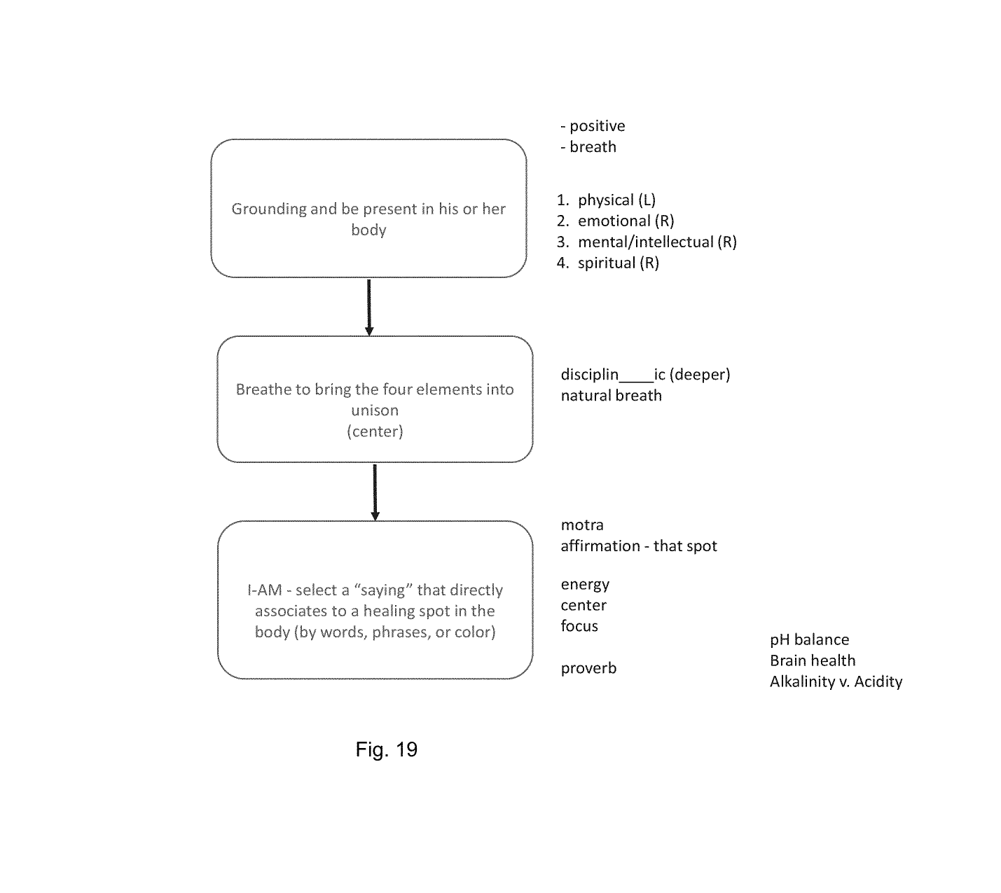

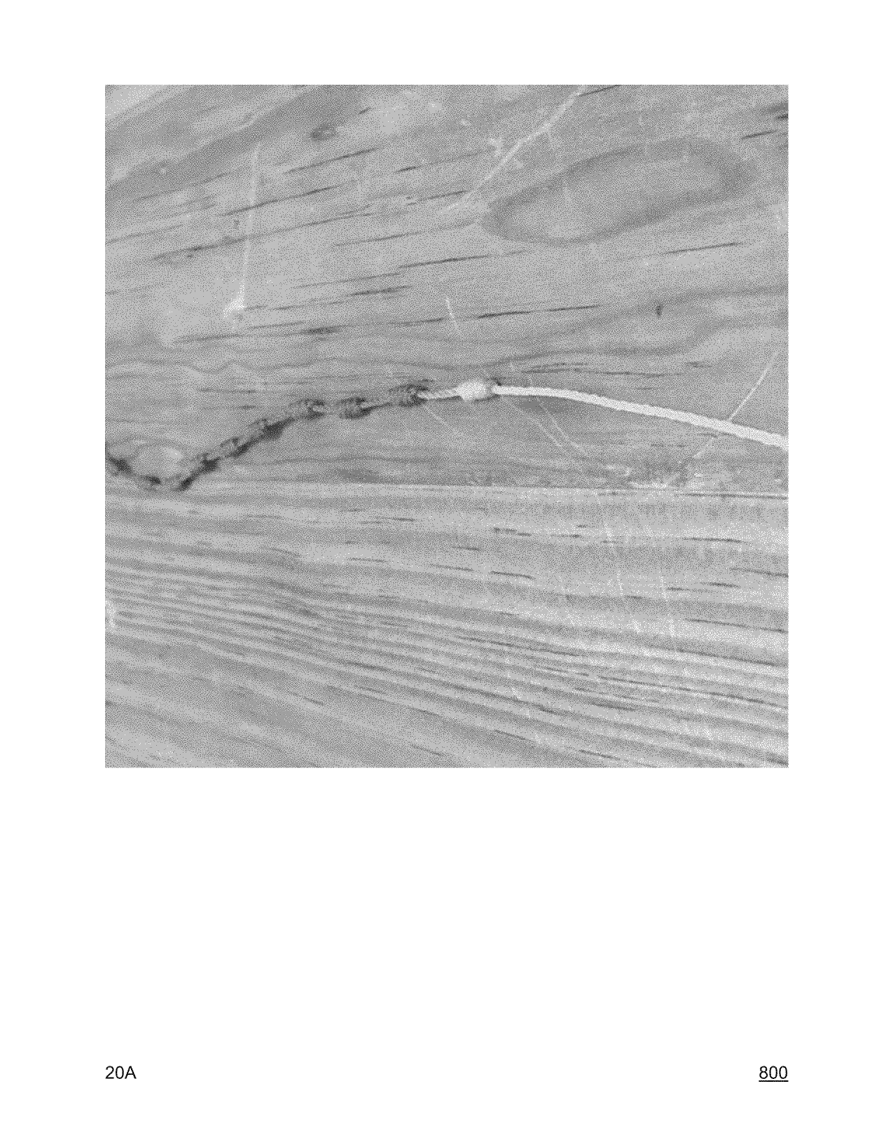

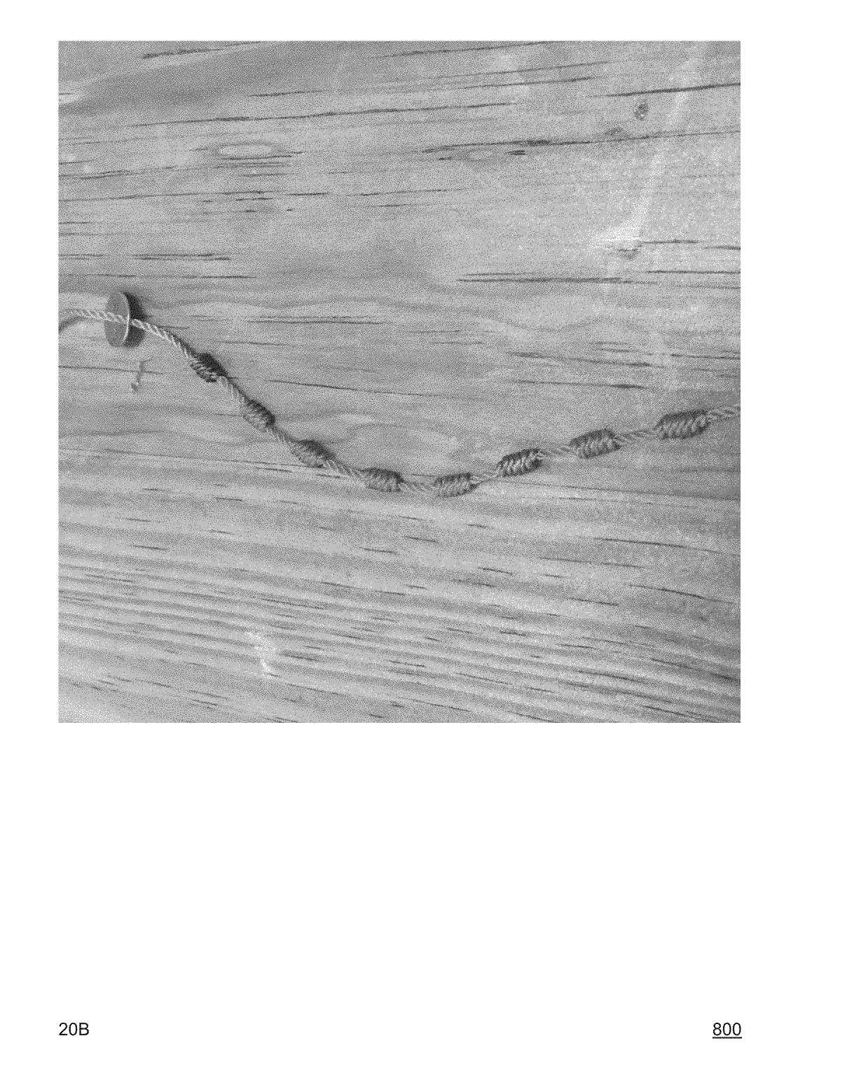

FIGS. 15-17 show a plurality of diagrams of a plurality of storage mediums with a plurality of meditation instructions according to this disclosure. FIG. 18 shows a diagram of an embodiment of a meditation technique according to this disclosure. FIG. 19 shows a flowchart of an embodiment of a meditation technique according to this disclosure. In particular, the storage mediums can include a paper, a plastic, a metal, a rubber, a wood, a stone, a fabric, a textile, a leather, a disc, a set of processor executable instructions, a data structure, or others. For additional details on meditation contents, please see Willard, Jill, “Intuitive Being: connect with Spirit, Find Your Center, and Choose an Intentional Life,” New York, HarperCollins, 2016, https://www.amazon.com/Intuitive-Being-Connect-Spirit-Intentional/dp/0062436546/ref=sr_1_1?ie=UTF8&qid=1477428694&sr=8-1&keywords=jill+willard, which is incorporated by reference herein in its entirety.

The first device 104 or the second device 106 can output a word diagram that illustrates one embodiment for the different types of sayings, with corresponding colors, that associate with a person's specific body parts. In the embodiment, a color red is associated with first part of the body: hips, sit bones, legs, knees, ankles, fat bottom and feet. A color orange is associated with the second part of the body: reproductive/sensual organs. A color yellow is associated with the third part of the body: stomach. A color green is associated with the fourth part of the body: heart and shoulders. A color blue is associated with the fifth part of the body: throat. A color purple is associated with the sixth part of the body: throat. A color gray is associated with the fifth part of the body: top of the head/crown.

A bracelet, such as the bracelet 600, can be used in conjunction with the first device 104 or the second device 106 to enhance a meditation experience. The bracelet is a length of strong cord made by twisting together three separate strands of natural fibers. A single strand of string is used. One end of the string (a) folds toward the other end (b) forming a ‘U’ shape, about an inch in length. Both tips (a) and (b) are now pointed in the same direction. Using the length of string that leads to (b), but on the opposite side of the ‘U” shape as (a), the string begins to wrap around both sides of the ‘U” shape in the direction of the folded end. The string wraps around itself five times. The tip of (b) is then threaded thru the loop at the end of the CU′ shape and the two ends are pulled tight to secure the bond. Each pulse or knot is made the same way with regard to process. In some embodiments, the fabric 700 can be used.

The bracelet can be used as a calming and counting tool. Each rope tie represents a pause and a connection to a meditation thought, such as I Am of choice. Each color represents an energy center and key aspect of being.

The fabric 700 can be used to find a spot, space, or mental connection to a meditation practice, ritual and routine. The fabric 700 also holds a juju or meditative energy of each meditation a user does, which may be an important and rich collective spirit/energy to help each meditation and centering experience.

A kit, which include the first device 104 or the second device 106, can be formed for a meditative experience to create a sacred space and having simple tools to create and carve out a meditative practice and experience for mind and body.

A journal can be used, whether via the first device 104 or the second device 106, to log anything and everything that comes in after meditating. Key to noticing both our intuition and the powerful ideas and thoughts that come in after a bit of centering silence. Good to collect and go back and look what came in. Helps ideas and conclusions to not become lost after our bit of quiet.

A charm, which may be provided in a kit of two or more, can be provided for children, as a token and act of connection to our self, others and our expression of feeling, emotion and intimate acknowledgement of what we feel toward celebration of self and other. Two or more belief support. Supporting energy and forms of imagery and tactile support.

An important part of children's experience is letting emotion go or being comfortable talking and sharing feelings. Help nervous system and/or children feel in their sacred safe space. Helps when room or space cool, or if children want to turn into bolster or sitting mat. Part of both I AM kids and Present Program.

A cape, such as a child cape, for expression, bravery and creative support. Wonderful as gifts and or play. For a class and for building children's confidence in self-expression and creative play. Owning self-worth and being self.

A structure, such as a tent, a teepee, or others, can be used to create a sacred space for kids. Great design and play/decor as well.

A line, such as a cord, a rope, a chain, a belt, or others, can be a rope/bracelet for group adult classes and same 12 knots for soothing, slowing down technique. Can be provided individually or in bulk.

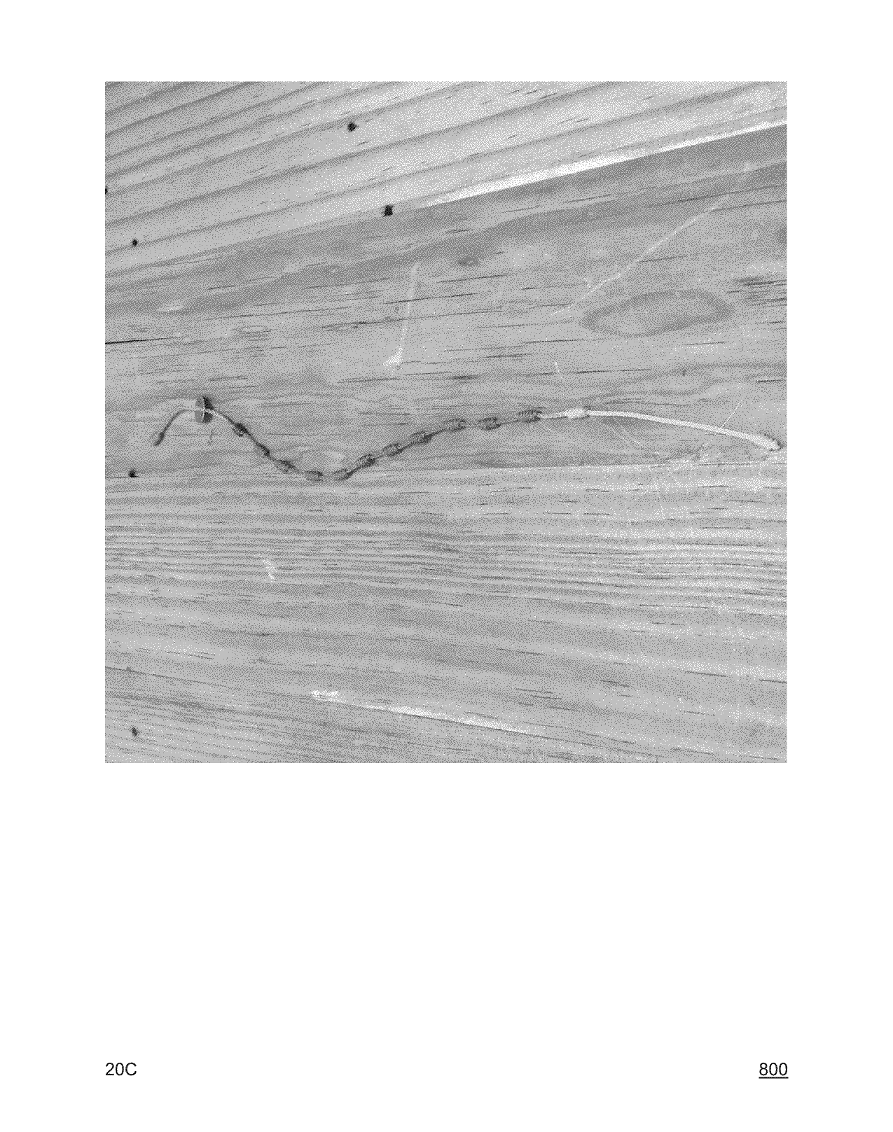

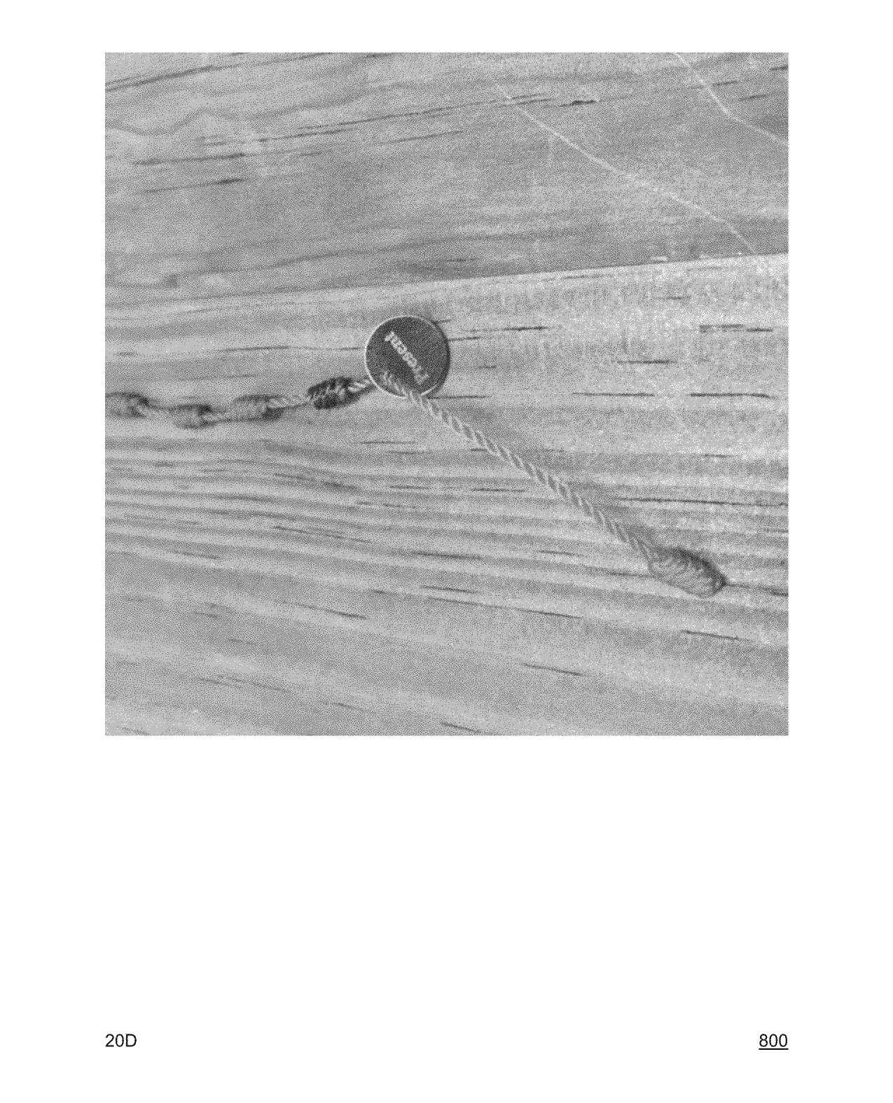

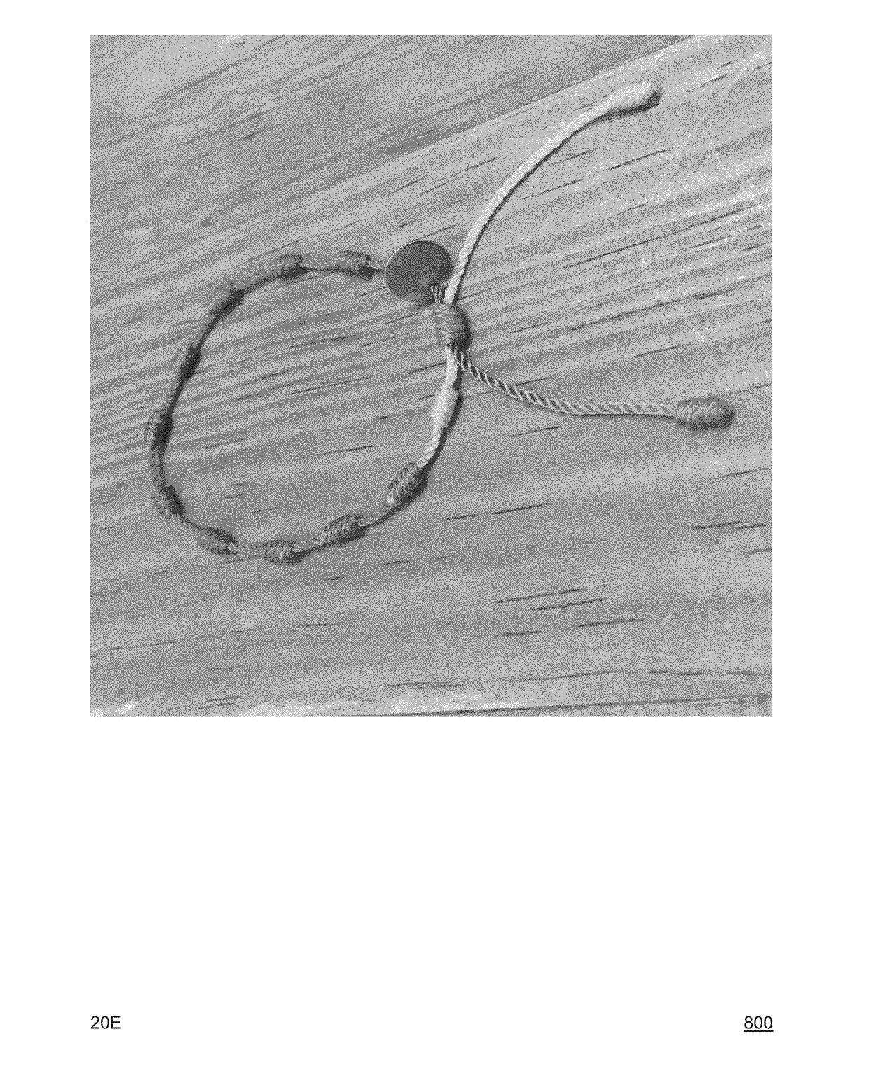

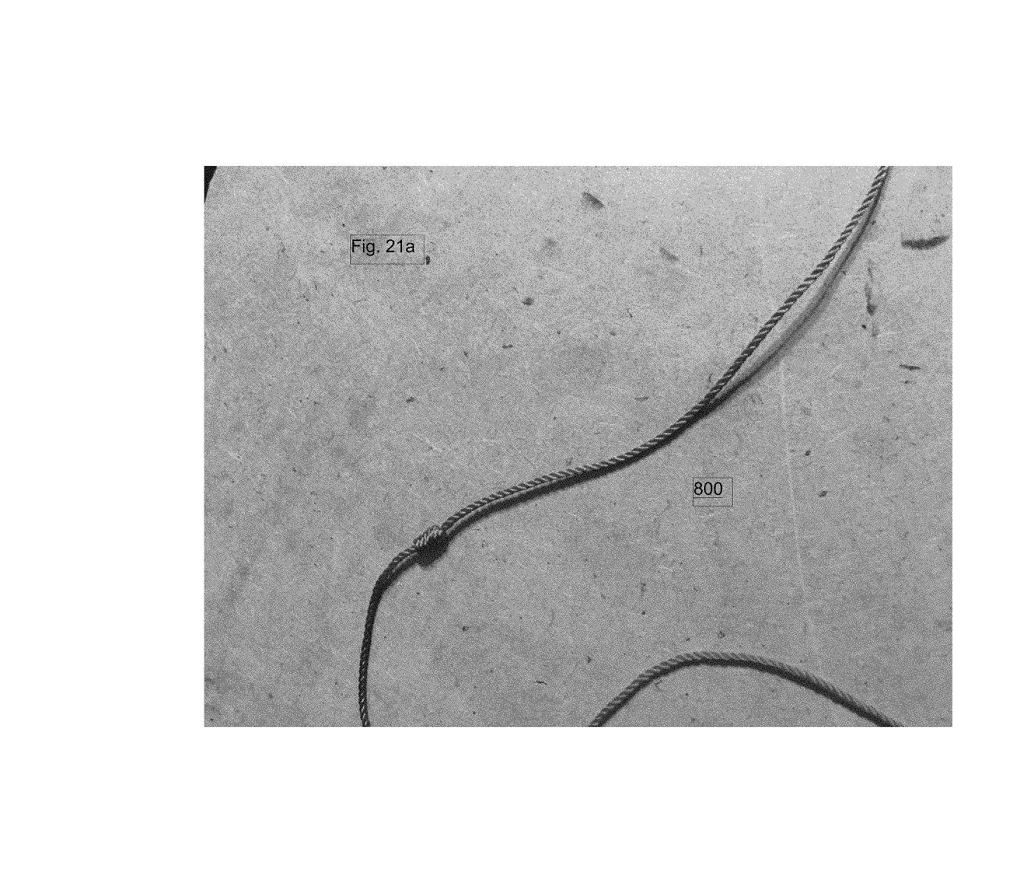

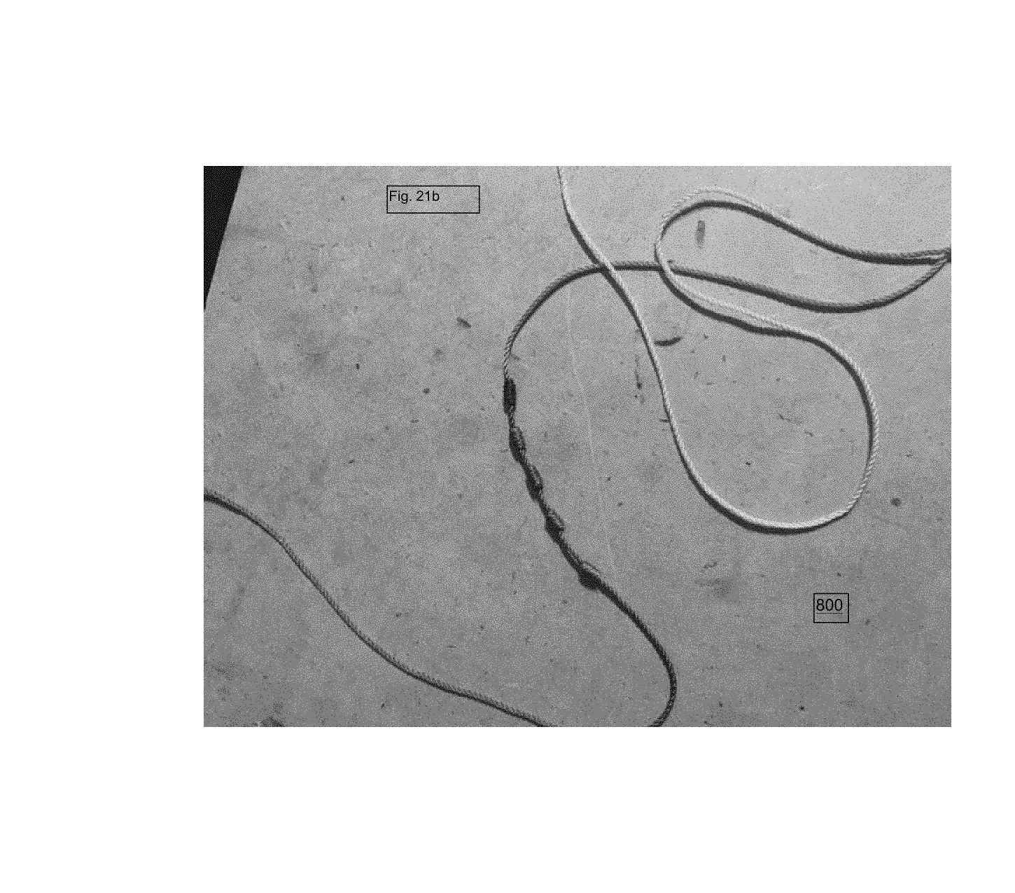

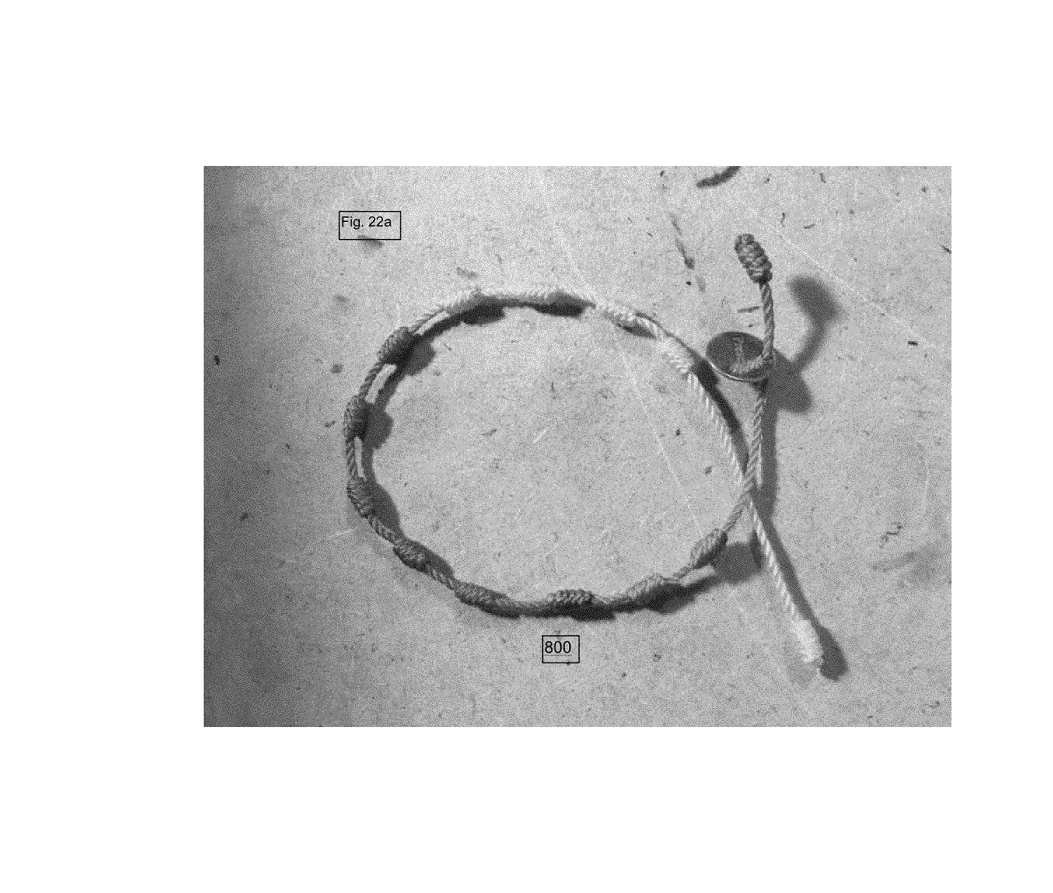

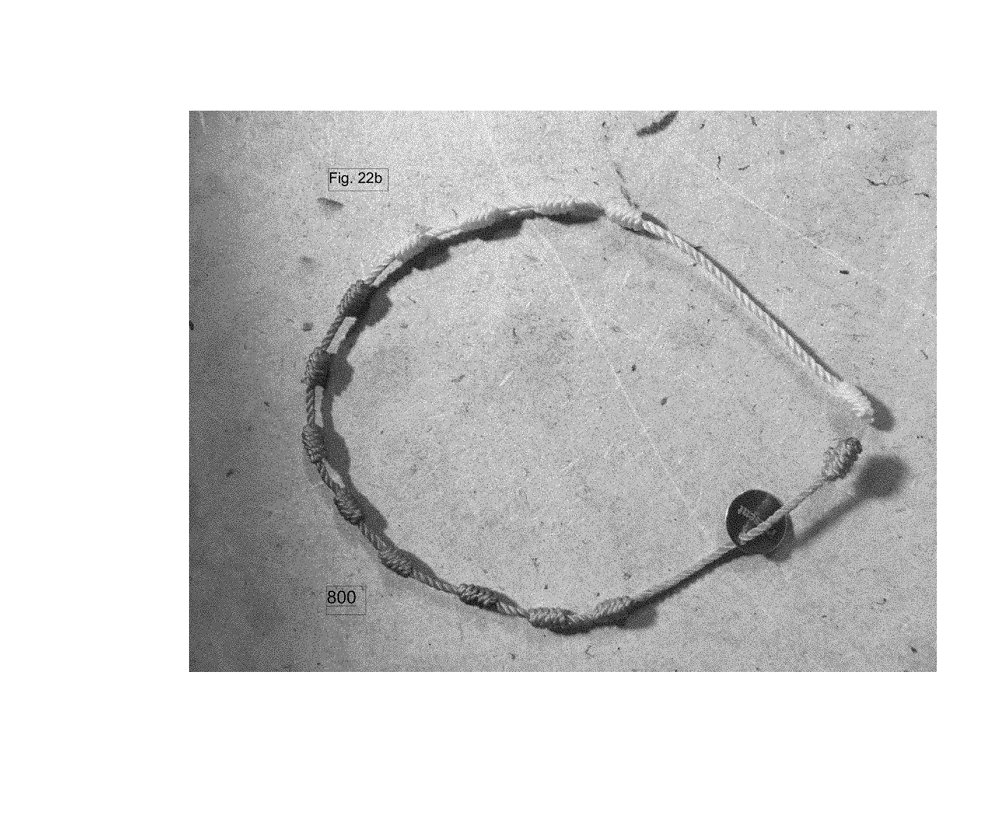

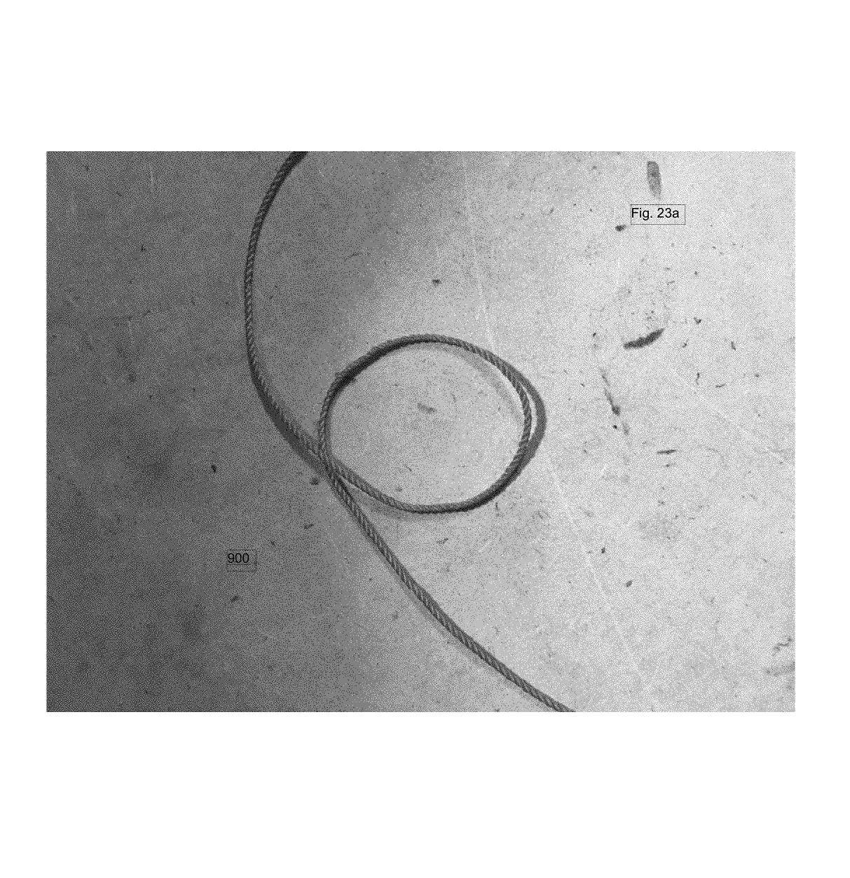

FIGS. 20a-20e show a diagram of an embodiment of a bracelet with visually distinct segments according to this disclosure. FIGS. 21a-21b show a diagram of an embodiment of a cord with visually distinct segments according to this disclosure. FIGS. 22a-22b show a diagram of an embodiment of a cord with linearly spaced features and a member mounted onto the cord according to this disclosure. In particular, a tactile bracelet 800 is similar to the tactile bracelet 600, except for a plurality of visually distinct segments of the cord 602. As shown, the visually distinct segments are visually distinct based on color, but hatching or other ways are possible.

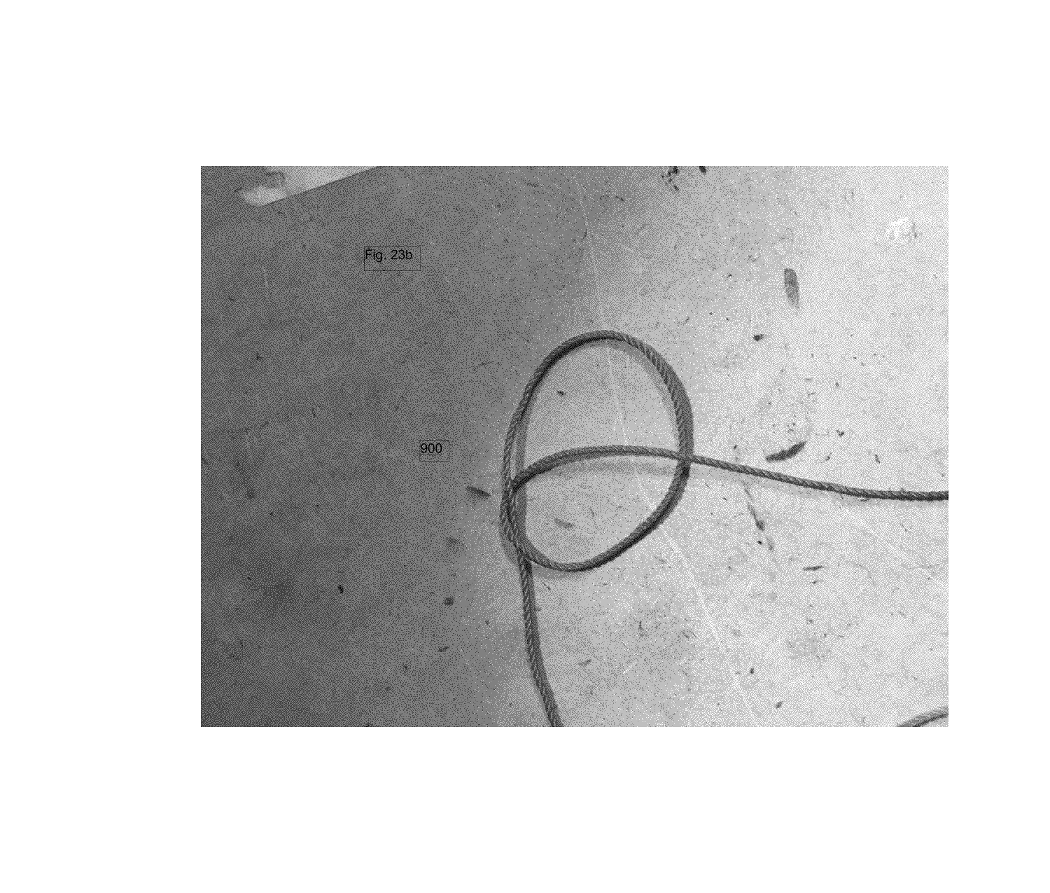

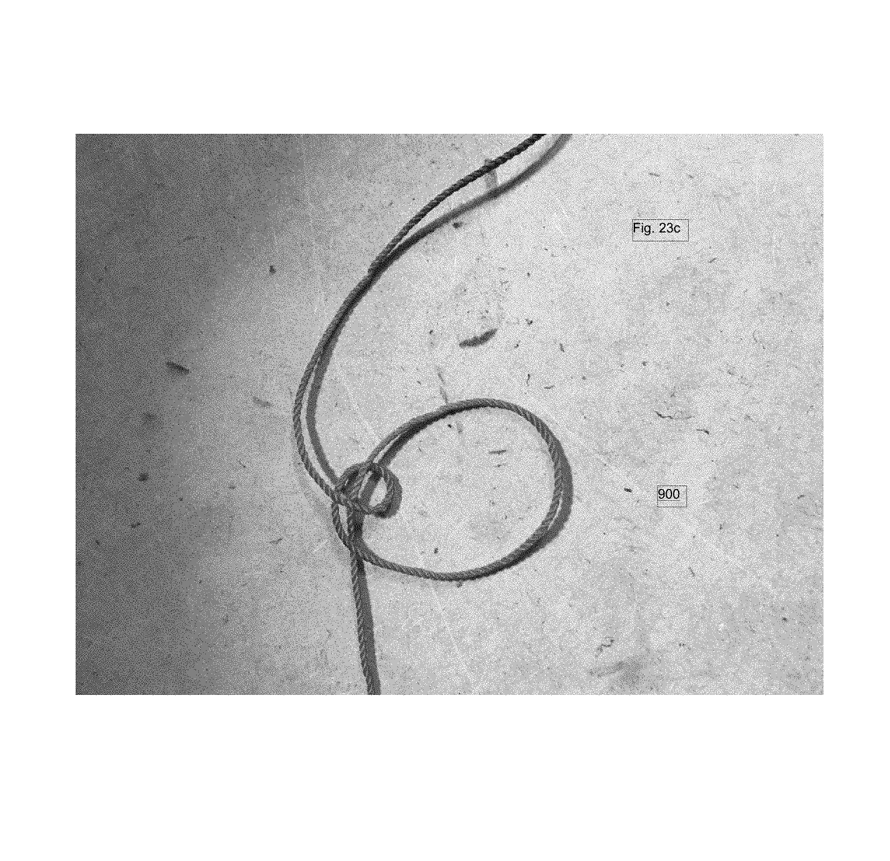

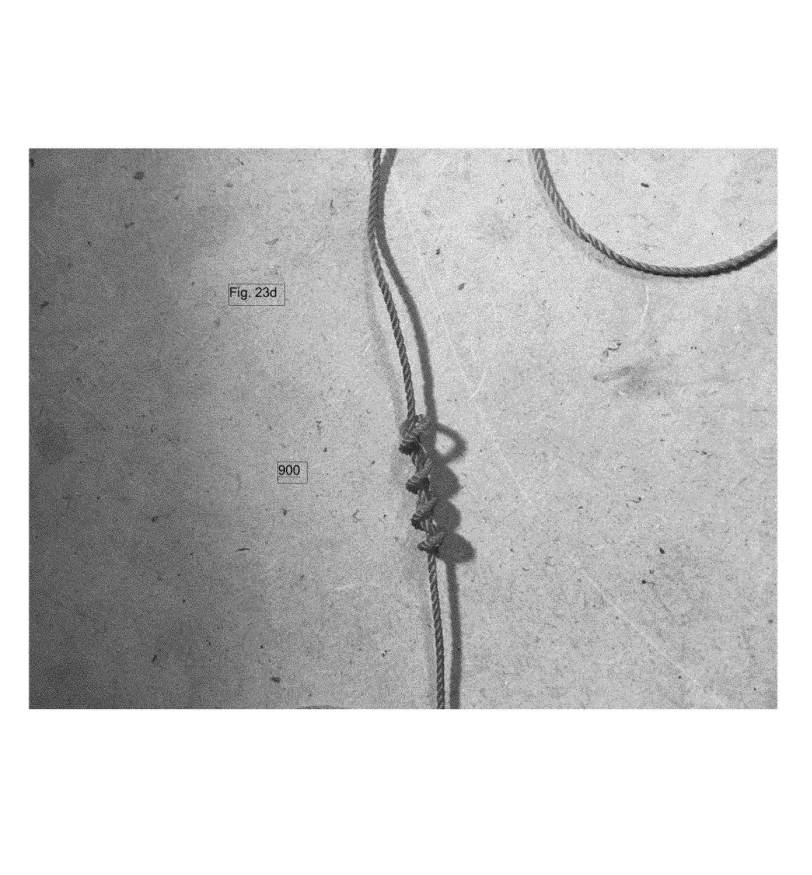

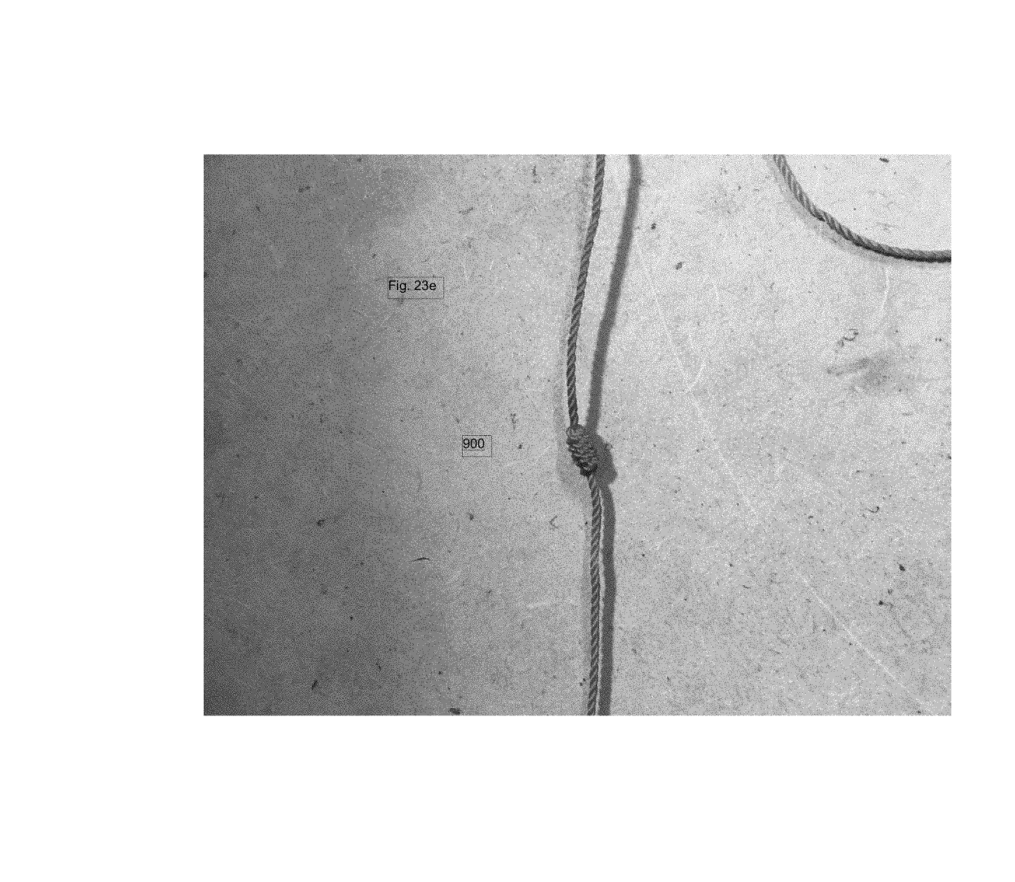

FIGS. 23a-23e show a diagram of an embodiment of a bracelet tying technique with a cord according to this disclosure. In particular, a bracelet tying technique 900 includes (1) extending a cord so that a closed shape is formed, as shown in FIG. 23a, (2) extending the cord through the closed shape, as shown in FIG. 23b, (3) extending the cord about the closed shape, as shown in FIG. 23c, (4) helically extend the cord about the closed shaped at least once, such as five times or more or less, as shown in FIGS. 23d, and (5) pull the cord from ends to tighten, as shown in FIG. 23e. As such, a helical knot is formed along the cord and other features can be included on the cord, such as knots, beads, or others, whether in an equidistant or non-equidistant manner. Note that FIGS. 23a-23e show that there are six loops per knot, although this number can vary higher or lower. In some use cases, a bracelet maker may need to place the six loops in order (as one loop may go on top of or overlap another), and pull the cord to tighten in order to make one knot.

Features described with respect to certain example embodiments can be combined and sub-combined in and/or with various other example embodiments. Also, different aspects and/or elements of example embodiments, as disclosed herein, can be combined and sub-combined in a similar manner as well. Further, some example embodiments, whether individually and/or collectively, can be components of a larger system, wherein other procedures can take precedence over and/or otherwise modify their application. Additionally, a number of steps can be required before, after, and/or concurrently with example embodiments, as disclosed herein. Note that any and/or all methods and/or processes, at least as disclosed herein, can be at least partially performed via at least one entity in any manner.

Example embodiments of this disclosure are described herein with reference to illustrations of idealized embodiments (and intermediate structures) of this disclosure. As such, variations from various illustrated shapes as a result, for example, of manufacturing techniques and/or tolerances, are to be expected. Thus, various example embodiments of this disclosure should not be construed as necessarily limited to various particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing, and/or other any other types of manufacturing. For example, some manufacturing processes include three dimensional (3D) printing, laser cutting, computer numerical control routing, milling, pressing, stamping, vacuum forming, hydroforming, injection molding, lithography, and so forth.

Any and/or all elements, as disclosed herein, can be and/or include, whether partially and/or fully, a solid, including a metal, a mineral, an amorphous material, a ceramic, a glass ceramic, an organic solid, such as wood and/or a polymer, such as rubber, a composite material, a semiconductor, a nanomaterial, a biomaterial and/or any combinations thereof. Any and/or all elements, as disclosed herein, can be and/or include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, opaqueness, luminescence, reflection, phosphorescence, anti-reflection and/or holography, a photo-sensitive coating, an electronic and/or thermal property coating, such as for passivity, insulation, resistance or conduction, a magnetic coating, a water-resistant and/or waterproof coating, a scent coating and/or any combinations thereof. Any and/or all elements, as disclosed herein, can be rigid, flexible, and/or any other combinations thereof. Any and/or all elements, as disclosed herein, can be identical and/or different from each other in material, shape, size, color and/or any measurable dimension, such as length, width, height, depth, area, orientation, perimeter, volume, breadth, density, temperature, resistance, and so forth.

Unless otherwise defined, all terms (including technical and scientific terms) used herein have the same meaning as commonly understood by one of ordinary skill in an art to which this disclosure belongs. Various terms, such as those defined in commonly used dictionaries, should be interpreted as having a meaning that is consistent with a meaning in a context of a relevant art and should not be interpreted in an idealized and/or overly formal sense unless expressly so defined herein.

Furthermore, relative terms such as “below,” “lower,” “above,” and “upper” can be used herein to describe one element's relationship to another element as illustrated in the set of accompanying illustrative drawings. Such relative terms are intended to encompass different orientations of illustrated technologies in addition to an orientation depicted in the set of accompanying illustrative drawings. For example, if a device in the set of accompanying illustrative drawings were turned over, then various elements described as being on a “lower” side of other elements would then be oriented on “upper” sides of other elements. Similarly, if a device in one of illustrative figures were turned over, then various elements described as “below” or “beneath” other elements would then be oriented “above” other elements. Therefore, various example terms “below” and “lower” can encompass both an orientation of above and below.

As used herein, a term “about” and/or “substantially” refers to a +/−10% variation from a nominal value/term. Such variation is always included in any given value/term provided herein, whether or not such variation is specifically referred thereto.

In some embodiments, various functions or acts can take place at a given location and/or in connection with the operation of one or more apparatuses or systems. In some embodiments, a portion of a given function or act can be performed at a first device or location, and a remainder of the function or act can be performed at one or more additional devices or locations.

Various corresponding structures, materials, acts, and equivalents of all means or step plus function elements in various claims below are intended to include any structure, material, or act for performing the function in combination with other claimed elements as specifically claimed. Various embodiments were chosen and described in order to best explain various principles of this disclosure and various practical applications thereof, and to enable others of ordinary skill in a pertinent art to understand this disclosure for various embodiments with various modifications as are suited to a particular use contemplated.

Various diagrams depicted herein are illustrative. There can be many variations to such diagrams or steps (or operations) described therein without departing from various spirits of this disclosure. For instance, various steps can be performed in a differing order or steps can be added, deleted or modified. All of these variations are considered a part of this disclosure. People skilled in an art to which this disclosure relates, both now and in future, can make various improvements and enhancements which fall within various scopes of various claims which follow.

This detailed description has been presented for various purposes of illustration and description, but is not intended to be fully exhaustive and/or limited to this disclosure in various forms disclosed. Many modifications and variations in techniques and structures will be apparent to those of ordinary skill in an art without departing from a scope and spirit of this disclosure as set forth in various claims that follow. Accordingly, such modifications and variations are contemplated as being a part of this disclosure. A scope of this disclosure is defined by various claims, which include known equivalents and unforeseeable equivalents at a time of filing of this disclosure.

What is claimed is:

1. A method comprising:
receiving, via a mobile device, a pH reading from a wearable device, wherein the wearable device includes a pH sensor that obtained the pH reading, wherein the mobile device stores a key and a first meditation content, wherein the key maps onto the first meditation content;
accessing, via the mobile device, the first meditation content based on the pH reading corresponding to the key;
outputting, via the mobile device, the first meditation content;
receiving, via the mobile device, a user input responsive to the first meditation content; and
taking, via the mobile device, an action responsive to the user input.

2. The method of claim 1, wherein the wearable device is a bracelet, wherein the bracelet includes a plurality of features and a member, wherein the member is configured to travel over the features.

3. The method of claim 2, wherein the features include at least one of a knot or a bead.

4. The method of claim 1, wherein the wearable device is a headphone.

5. The method of claim 1, wherein the wearable device is a garment.

6. The method of claim 1, wherein the wearable device is a contact lens.

7. The method of claim 1, wherein the wearable device is a jewelry item.

8. The method of claim 1, wherein the wearable device is a hearing aid.

9. The method of claim 1, wherein the first meditation content enables a selection of a color from a plurality of colors generated based on the pH reading, wherein the user input selects the selection of the color from the colors.

10. The method of claim 9, wherein the wearable device is a bracelet that is includes a plurality of portions that are visually distinct from each other by the colors.

11. The method of claim 1, wherein the pH sensor is a first sensor, wherein the pH reading is a first reading, wherein the mobile device is in communication with a second sensor configured to obtain a second reading, wherein the first meditation content is generated based on the first reading and the second reading.

12. The method of claim 11, wherein the mobile device includes the second sensor.

13. A method comprising:
adhering a patch to a forehead of a user, wherein the patch includes a pH sensor configured to obtain a pH reading from the forehead; and
transmitting the pH reading from the patch to a mobile device.

14. The method of claim 13, further comprising:
accessing, via the mobile device, the first meditation content based on the pH reading corresponding to the key;
outputting, via the mobile device, the first meditation content;
receiving, via the mobile device, a user input responsive to the first meditation content; and
taking, via the mobile device, an action responsive to the user input.

15. The method of claim 13, wherein the first meditation content enables a selection of a color from a plurality of colors generated based on the pH reading, wherein the user input selects the selection of the color from the colors.

16. The method of claim 13, wherein the pH sensor is a first sensor, wherein the pH reading is a first reading, wherein the patch includes a second sensor configured to obtain a second reading, wherein the first meditation content is generated based on the first reading and the second reading.

17. The method of claim 13, wherein the pH sensor is a first sensor, wherein the pH reading is a first reading, wherein the mobile device is in communication with a second sensor configured to obtain a second reading, wherein the first meditation content is generated based on the first reading and the second reading.

18. The method of claim 17, wherein the mobile device includes the second sensor.

19. A device comprising:
a headphone including a headband and an earpiece; and
a pH sensor, wherein at least one of the headband or the earpiece includes the pH sensor.

20. The device of claim 19, wherein the earpiece includes the pH sensor.
